(19) United States
(12) Patent Application Publication
(10) Pub. No.: US 2026/0168464 A1
(43) Pub. Date: Jun. 18, 2026

(54) SYSTEMS AND METHODS FOR ROTATING DETONATION COMBUSTION SATELLITE THRUSTERS

(71) Applicant: Juno Propulsion Inc., Tukwila, WA (US)

(72) Inventors: Ariana MARTINEZ, Federal Way, WA (US); Alexis HARROUN, Federal Way, WA (US)

(73) Assignee: Juno Propulsion Inc., Tukwila, WA (US)

(21) Appl. No.: 19/532,994

(22) Filed: Feb. 6, 2026

Related U.S. Application Data
(63) Continuation of application No. PCT/US25/14213, filed on Jan. 31, 2025.
(60) Provisional application No. 63/548,791, filed on Feb. 1, 2024.

(51) Int. Cl. F02K 9/66; B64G 1/40; F02K 9/52

(52) U.S. Cl. CPC F02K 9/66; B64G 1/401; B64G 1/402; F02K 9/52

(57) ABSTRACT

A thruster operable for use in a satellite may include a rotating detonation combustion chamber; a fuel source operably connected to the rotating detonation combustion chamber, the fuel source comprising two chemical propellants, wherein each of the two chemical propellants comprises a liquid with a vapor pressure sufficient to self-pressurize each of the two chemical propellants; and a valve system configured to control a feed of each of the two chemical propellants to the rotating detonation combustion chamber.

### CROSS-REFERENCE

This application is a continuation of PCT Application No. PCT/US25/14213, filed Jan. 21, 2025, which claims the benefit of U.S. Provisional Application No. 63/548,791, filed Feb. 1, 2024, each of which is incorporated herein by reference.

### BACKGROUND

The space economy is currently a $447B USD industry and rapidly growing to a projected $ 1T USD industry by 2030. However, current estimates place the cost of launch to space near $5-10K USD per kilogram of payload and the cost of the satellite itself may range widely from millions to hundreds of millions. The capabilities, and thus the value, of a satellite may be limited by the performance of the propulsion system on board.

### SUMMARY

Disclosed herein is a thruster. The thruster can comprise a rotating detonation combustion chamber. The thruster can comprise a fuel source operably connected to the rotating detonation combustion chamber. The fuel source can comprise two chemical propellants. In some cases, each of the two chemical propellants comprises a liquid with a vapor pressure higher than an operating pressure of each of the two chemical propellants.

Provided herein is a thruster comprising a rotating detonation combustion chamber. The thruster can comprise a fuel source operably connected to the rotating detonation combustion chamber. The fuel source can comprise two chemical propellants. In some cases, a first of the two chemical propellants comprises nitrous oxide.

Disclosed herein is a thruster comprising a rotating detonation combustion chamber. The thruster can comprise a fuel source operably connected to the rotating detonation combustion chamber. The fuel source can comprise two chemical propellants. The thruster can comprise a valve system configured to control a feed of each of the two chemical propellants to the rotating detonation combustion chamber. In some cases, the valve system is configured to selectively draw on either a vapor or a liquid phase of a propellant of the two chemical propellants.

Provided herein is a thruster comprising a rotating detonation combustion chamber. The thruster can comprise a fuel source operably connected to the rotating detonation combustion chamber. The fuel source can comprise two chemical propellants. The thruster can comprise an ignition source. In some cases, the ignition source comprises a catalytic decomposition of one of the two chemical propellants.

Disclosed herein is a system comprising a thruster as described above and a tank for the each of the two chemical propellants.

Provided herein is a method of generating a detonation in a rotating detonation combustion chamber. The method can comprise providing a rotating detonation combustion chamber. The method can comprise providing a fuel source. In some cases, the fuel source comprises two chemical propellants. In some cases, each of the two chemical propellants comprises a liquid with a vapor pressure higher than an operating pressure of each of the two chemical propellants.

Disclosed herein is a method of generating a detonation in a rotating detonation combustion chamber. The method can comprise providing a rotating detonation combustion chamber. The method can comprise providing a fuel source. In some cases, the fuel source comprises two chemical propellants. In some cases, a first of the two chemical propellants comprises nitrous oxide.

Provided herein is a method of generating a detonation in a rotating detonation combustion chamber. The method can comprise providing a rotating detonation combustion chamber. The method can comprise providing a fuel source. In some cases, the fuel source comprises two chemical propellants. The method can comprise providing a valve system. The method can comprise controlling, via the valve system, a feed of each of the two chemical propellants to the rotating detonation combustion chamber. The method can comprise selectively drawing, via the valve system, on either a vapor or a liquid phase of a propellant of the two chemical propellants.

Disclosed herein is a method of generating a detonation in a rotating detonation combustion chamber. The method can comprise providing a rotating detonation combustion chamber. The method can comprise providing a fuel source. In some cases, the fuel source comprises two chemical propellants. The method can comprise catalytically decomposing one of the two chemical propellants. In some cases, the product of the catalytic decomposition comprises an ignition source.

Provided herein is a thruster comprising a rotating detonation combustion chamber. The thruster can comprise a fuel source operably connected to the rotating detonation combustion chamber. The fuel source can comprise two chemical propellants. In some cases, each of the two chemical propellants comprises a liquid with a vapor pressure sufficient to self-pressurize each of the two chemical propellants.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIGS. 1A-1B illustrate a graphical comparison of examples of the devices described herein compared to other thrusters, in accordance with some embodiments.

FIG. 2 illustrates a perspective computational view of the inside of a combustion chamber, in accordance with some embodiments.

FIG. 3 illustrates a graphical comparison of the specific impulse of examples of the devices described herein described herein compared to other thrusters, in accordance with some embodiments.

FIGS. 4A-4C illustrates perspective (FIG. 4A) and cross-sectional (FIGS. 4B-4C) views of an example embodiment of a thruster, in accordance with some embodiments.

FIGS. 5A-5D illustrate schematic views of the inside of an example thruster, in accordance with some embodiments.

FIG. 6 illustrates a graph of the combustion window as a matter of time and pressure, in accordance with some embodiments.

FIG. 7 illustrates a two-dimensional schematic of a detonation wave and cell-structure, in accordance with some embodiments.

FIG. 8 illustrates an example flow field simulation result using the Euler equation based on an RDC model, in accordance with some embodiments.

FIG. 9 illustrates an example detonation wave over a period of time, in accordance with some embodiments.

FIG. 10 illustrates a graphical diagram of an example of plumbing and instrumentation of propellant feed systems in an example of thrusters and systems described herein, in accordance with some embodiments.

FIGS. 11-14 illustrates flowcharts of example methods of causing a detonation in an example thruster, in accordance with some embodiments.

### DETAILED DESCRIPTION

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

Chemical rocket engines may be used to power launch vehicles into space, move satellites in orbit, and propel scientific missions to the moon and beyond. The performance of the engine may exponentially increase the amount of mass sent to space and thus may impact mission capability and cost of operation. The engines used today are based on combustion physics that have had few to no paradigm changes since the 1950s. This plateau in engine performance may limit mission capability and drive the cost to launch to space, estimated near $5-10K per kilogram of payload.

Alternatives to constant pressure combustion (CPC) engines using toxic propellants may be advantageous for various regulatory requirements. Regulatory requirements may include a requirement for controlled deorbiting at the end of life. Higher thrust maneuvers, which may be implemented by chemical propulsion systems, may bring satellites in low earth orbit (LEO) through the orbital plane of the International Space Station. Another regulatory pressure may include the move toward non-toxic propellants. The disclosure below may provide high thrust for enhanced de-orbiting capability and use alternative, non-toxic fuels to lead the transition to a safer, non-toxic propulsion market. Non-toxic, “green” propellants may be of benefit for commercial and defense purposes. Currently, hydrazine may be foreign-sourced. The chemical propellants disclosed can be domestically sourced, providing a more secure supply chain and significantly reduced cost. The use of hydrazine can limit launch locations to specialized, expensive loading facilities. The chemical propellants proposed may be relatively safe for loading around humans and can be loaded into the propulsion system from many different locations. The overall system design for the non-toxic propulsion system can be simpler than the hydrazine-based system, removing potential failure points.

Such alternatives can include satellite thrusters using rotating detonation combustion (RDC). Provided herein are systems and methods for satellite thrusters RDC. This may include the thruster based on the RDC concept and the full system used to deliver propellant to the thruster. The propellants may be non-toxic.

### Rotating Detonation Combustion

Described herein are thrusters using rotating detonation combustion (RDC). Rotating detonation combustion may be a chemical propulsion concept that may raise the ceiling of combustion performance beyond conventional rocket engines. RDCs can utilize a different type of combustion called detonation, where the propellants are burned at a higher pressure, achieving higher combustion efficiency. A higher combustion efficiency can correlate to an increase in thermal energy created with the same amount of base fuels or oxidizers, which can then be converted to a larger amount of kinetic energy for propulsion with the same amount of base fuels or oxidizers. In an RDC, propellant may be injected into the chamber and a detonation wave may travel tangentially to this flow, burning the reactants, before the products are expanded through a nozzle. This higher performance may allow for a reduction in propellant mass on board to achieve the same mission objectives.

In some cases, the detonation wave may transition to longitudinal waves spanning part or all of the annular chamber as the combustion proceeds.

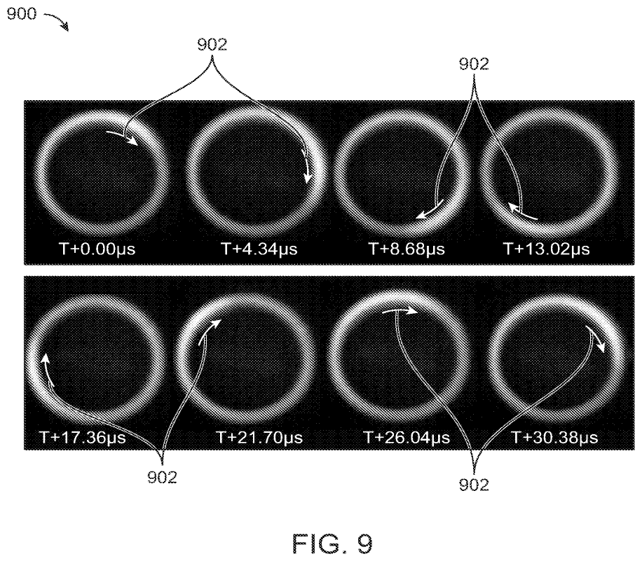

In a detonation combustor, including the rotating ones disclosed herein, the combustion of the fuel and oxidizer mixture can comprise a more explosive effect rather than a burning effect as in CPCs. In CPCs, the flame propagation may be a function of heat transfer from a reactive zone to the mixture through conduction. In contrast, in a detonation combustor, the detonation can be a shock induced flame, which may result in the coupling of a reaction zone, melding of a reaction zone, or both and a shockwave. The shockwave, or detonation wave as referred to herein, may compress and heat the propellant mixture, thereby igniting it. Alternatively, the propellant may already be ignited via the ignition sources and methods described herein, such as catalytic decomposition. Energy released by the combustion can contribute to the propagation of the detonation wave. With continued detonation, the detonation wave can propagate around the combustion chamber in a continuous manner, thereby using it as a track. This can occur at a relatively high frequency of, as shown by the detonation wave cycles measured in microseconds in FIG. 9 (discussed below). Due in part to the detonation wave, the average pressure inside the combustion chamber can higher than an average pressure within a CPC thruster.

RDC thrusters may be large, on the order of about 100 lbf (pound-force). RDC thrusters may be on the order of from about 5 lbf to about 10 lbf. RDC thrusters may be on the order of from about 5 lbf to about 120 lbf. RDC thrusters may be on the order of from about 5 lbf to about 10 lbf, about 5 lbf to about 25 lbf, about 5 lbf to about 50 lbf, about 5 lbf to about 75 lbf, about 5 lbf to about 100 lbf, about 5 lbf to about 120 lbf, about 10 lbf to about 25 lbf, about 10 lbf to about 50 lbf, about 10 lbf to about 75 lbf, about 10 lbf to about 100 lbf, about 10 lbf to about 120 lbf, about 25 lbf to about 50 lbf, about 25 lbf to about 75 lbf, about 25 lbf to about 100 lbf, about 25 lbf to about 120 lbf, about 50 lbf to about 75 lbf, about 50 lbf to about 100 lbf, about 50 lbf to about 120 lbf, about 75 lbf to about 100 lbf, about 75 lbf to about 120 lbf, or about 100 lbf to about 120 lbf. RDC thrusters may be on the order of about 5 lbf, about 10 lbf, about 25 lbf, about 50 lbf, about 75 lbf, about 100 lbf, or about 120 lbf. RDC thrusters may be on the order of at least about 5 lbf, about 10 lbf, about 25 lbf, about 50 lbf, about 75 lbf, or about 100 lbf. RDC thrusters may be on the order of at most about 10 lbf, about 25 lbf, about 50 lbf, about 75 lbf, about 100 lbf, or about 120 lbf.

The thrust class can be from about 1 N to about 4,500 N. The thrust class can be from about 1 N to about 22 N, about 1 N to about 45 N, about 1 N to about 450 N, about 1 N to about 4,500 N, about 22 N to about 45 N, about 22 N to about 450 N, about 22 N to about 4,500 N, about 45 N to about 450 N, about 45 N to about 4,500 N, or about 450 N to about 4,500 N. The thrust class can be about 1 N, about 22 N, about 45 N, about 450 N, or about 4,500 N. The thrust class can be at least about 1 N, about 22 N, about 45 N, or about 450 N. The thrust class can be at most about 22 N, about 45 N, about 450 N, or about 4,500 N.

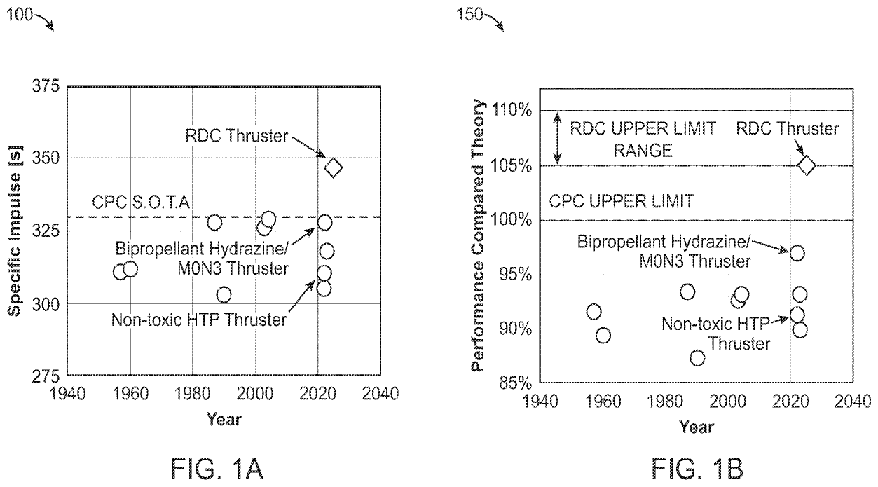

FIGS. 1A-1B illustrate a graphical comparison of examples of the devices described herein compared to other thrusters, based on reported values of the other thrusters and modeled values of the presently disclosed device. The model is based on performance evaluation code as described in Stechmann, David P., et al. “Rotating Detonation Engine Performance Model for Rocket Applications.” Journal of Spacecraft and Rockets, vol. 56, no. 3, December 2018, pp. 887-898, doi:10.2514/1.a34313, which is herein incorporated in its entirety. By using detonation, RDCs may achieve an estimated 5-10% higher specific impulse than constant pressure combustion engines, as shown in FIGS. 1A and 1B.

FIG. 1A illustrates a graph of the special impulse of a RDC thruster 100 as described herein versus leading CPC thrusters such as a bipropellant hydrazine/MON3 (nitrogen tetroxide with 3% nitric oxide) thruster or a HTP (high-test peroxide) thruster. Specific impulse can be impulse delivered per unit of propellant mass. By increasing the specific impulse of a satellite thruster by 10%, for example, a satellite may exponentially increase its lifespan in very low earth orbit, double imaging resolution by flying closer to the Earth, or elevate its orbit by hundreds of kilometers. This may extend the lifespan and enhance capabilities of satellites in orbit. In low earth orbit, the lifespan may be extended by about 100%. RDCs may also be used to enlarge satellite cameras, thereby increasing resolution capability by up to about 44%. The x-axis shows the creation years of the thrusters being compared.

FIG. 1B illustrates a graph of performance compared to theory of a RDC thruster 150 as described herein versus leading CPC thrusters such as a bipropellant hydrazine/MON3 (nitrogen tetroxide with 3% nitric oxide) thruster or a HTP (high-test peroxide) thruster. The x-axis shows the creation years of the thrusters being compared. The upper limit range can be between about 5%-10% higher than limit of CPC thrusters.

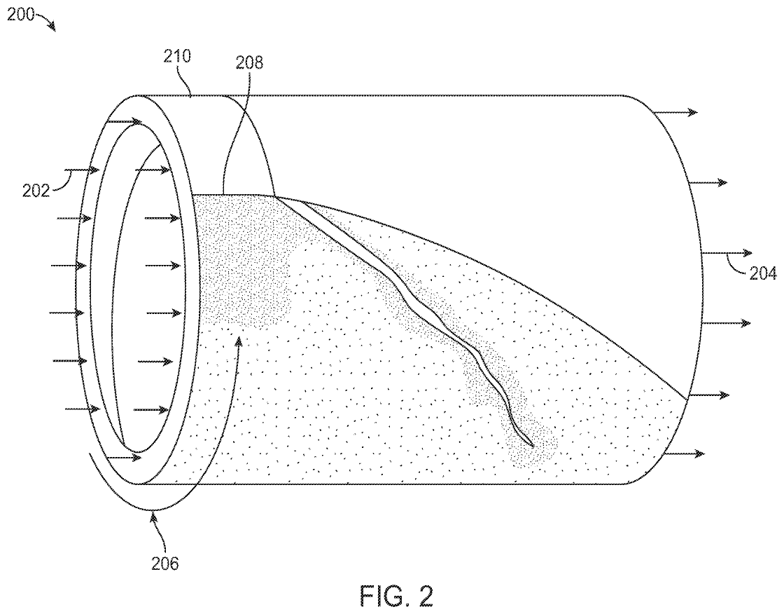

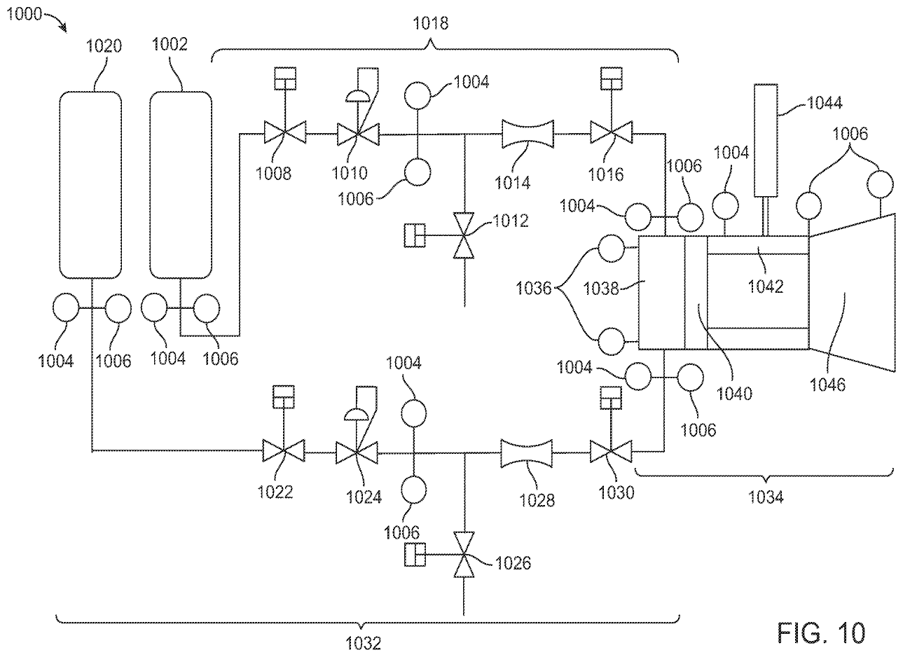

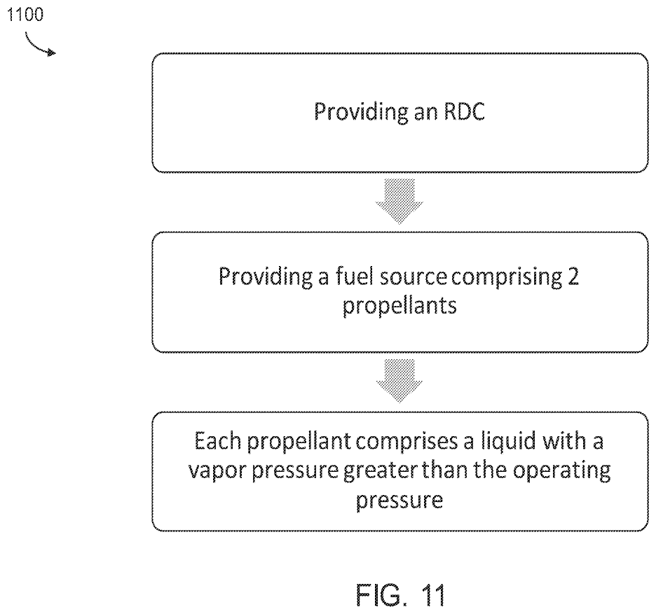

FIG. 2 illustrates a perspective view of a computational view of the inside of a combustion chamber 200 with axially-injected reactants 202, a circumferentially-travelling detonation wave 208, rotation of the detonation wave and post-combustion exhaust gases 206, and axially exhausting flow 204. As the gases rotate and the detonation wave travels, there can be an unburned fill region 210 that has not yet been combusted. The injector of an RDC system can be designed to prevent or minimize the ability of the high pressures within the region 210 from flowing in an upstream direction (e.g., into the incoming flow of the fuel/oxidizer mixture from the feed systems described below in FIG. 10).

In some cases, a fuel and oxidizer may be injected into the head-end of the RDC combustion chamber. As described above, the RDC may have one or more circumferentially-travelling detonation waves 208 that process and burn the incoming reactants 202, as shown in FIG. 2. The reactants may then be expanded behind the detonation wave through a nozzle to extract thrust. The nozzle, as described below, may integrate to the RDC combustion chamber and expand the high-frequency, high-pressure ratio waves to the appropriate back pressure.

### Propellants

Described herein are propellant chemicals for use in the thruster. The propellants may comprise a liquid with a vapor pressure sufficient to self-pressurize each propellant. The propellants may self-pressurize at a given temperature. The propellants may comprise an oxidizer and a fuel. In some cases, a bipropellant combination of nitrous oxide (N₂O) as the oxidizer and ethane (C₂H₆) as the fuel may be used. Nitrous oxide may improve reaction rate and performance over other propellants by at least 1%, 2%, 3%, 4%, 5%, 6%, 7%, 8%, 9%, 10%, 15%, or at least 20%. In some cases, nitrous oxide may be used with oxygen as the oxidizer. Mixtures of nitrous oxide and oxygen may improve reaction rate and performance relative to use of nitrous oxide alone. Mixtures of nitrous oxide and oxygen may improve ignition. Mixtures of nitrous oxide and oxygen may increase the pressure of the fluid. Accordingly, mixtures of nitrous oxide and oxygen may improve reaction rate and performance by at least 1%, 2%, 3%, 4%, 5%, 6%, 7%, 8%, 9%, 10%, 15%, or at least 20%.

In some cases, other fuels that suit the required thermodynamic state may be used, including but not limited to ethane, propane, n-butane, isobutane, ethylene, propylene, acetylene, ammonia, or combinations thereof. In some case, a monopropellant version may be used with nitrous oxide. The propellants may be non-toxic. The propellants may be storable. The propellants used herein may be safer compared to propellants such as hydrazine and nitrogen tetroxide (NTO).

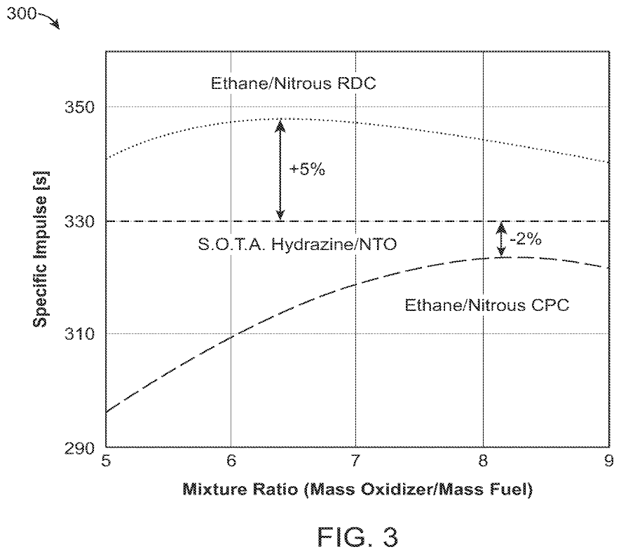

FIG. 3 illustrates a graphical comparison 300 of the specific impulse of examples of the devices described herein described herein compared to other thrusters. As shown in FIG. 3, use of nitrous oxide as the oxidizer and ethane as the fuel, in combination with an RDC, may improve the specific impulse by up to about 5% over a hydrazine and NTO thruster. The use of RDC with N₂O and ethane may improve the specific impulse by up to about 7% over a constant pressure combustion engine using the same propellants. The use of RDC with nitrous oxide and one of the fuels disclosed above (e.g., ethane, propane, n-butane, isobutane, ethylene, propylene, acetylene, ammonia, or combinations thereof) may improve the specific impulse by from about 1% to about 10%. The use of RDC with nitrous oxide and one of the fuels disclosed above may improve the specific impulse by from about 1% to about 2%, about 1% to about 3%, about 1% to about 4%, about 1% to about 5%, about 1% to about 6%, about 1% to about 7%, about 1% to about 8%, about 1% to about 9%, about 1% to about 10%, about 2% to about 3%, about 2% to about 4%, about 2% to about 5%, about 2% to about 6%, about 2% to about 7%, about 2% to about 8%, about 2% to about 9%, about 2% to about 10%, about 3% to about 4%, about 3% to about 5%, about 3% to about 6%, about 3% to about 7%, about 3% to about 8%, about 3% to about 9%, about 3% to about 10%, about 4% to about 5%, about 4% to about 6%, about 4% to about 7%, about 4% to about 8%, about 4% to about 9%, about 4% to about 10%, about 5% to about 6%, about 5% to about 7%, about 5% to about 8%, about 5% to about 9%, about 5% to about 10%, about 6% to about 7%, about 6% to about 8%, about 6% to about 9%, about 6% to about 10%, about 7% to about 8%, about 7% to about 9%, about 7% to about 10%, about 8% to about 9%, about 8% to about 10%, or about 9% to about 10% over a constant pressure combustion engine using the same propellants. The use of RDC with nitrous oxide and one of the fuels disclosed above may improve the specific impulse by about 1%, about 2%, about 3%, about 4%, about 5%, about 6%, about 7%, about 8%, about 9%, or about 10% over a constant pressure combustion engine using the same propellants. The use of RDC with nitrous oxide and one of the fuels disclosed above may improve the specific impulse by at least about 1%, about 2%, about 3%, about 4%, about 5%, about 6%, about 7%, about 8%, or about 9% over a constant pressure combustion engine using the same propellants. The use of RDC with nitrous oxide and one of the fuels disclosed above may improve the specific impulse by at most about 2%, about 3%, about 4%, about 5%, about 6%, about 7%, about 8%, about 9%, or about 10% over a constant pressure combustion engine using the same propellants.

The specific impulse may be greater than about 0 seconds, 50 seconds, 100 seconds, 150seconds, 200 seconds, 250 seconds, 300 seconds, 350 seconds, 400 seconds, or 450 seconds. The specific impulse may be less than about 50 seconds, 100 seconds, 150 seconds, 200 seconds, 250seconds, 300 seconds, 350 seconds, 400 seconds, or 450 seconds. The specific impulse can be between 300 and 400 seconds.

In some cases, when using a combination of nitrous oxide and oxygen as the oxidizer, the combination may improve the specific impulse over a constant pressure combustion engine using the same propellants by more than using nitrous oxide alone as the oxidizer. The use of RDC with nitrous oxide, oxygen, and one of the fuels disclosed above may improve the specific impulse by from about 2% to about 15% over a constant pressure combustion engine using the same propellants. The use of RDC with nitrous oxide, oxygen, and one of the fuels disclosed above may improve the specific impulse by from about 2% to about 4%, about 2% to about 6%, about 2% to about 8%, about 2% to about 10%, about 2% to about 12%, about 2% to about 15%, about 4% to about 6%, about 4% to about 8%, about 4% to about 10%, about 4% to about 12%, about 4% to about 15%, about 6% to about 8%, about 6% to about 10%, about 6% to about 12%, about 6% to about 15%, about 8% to about 10%, about 8% to about 12%, about 8% to about 15%, about 10% to about 12%, about 10% to about 15%, or about 12% to about 15% over a constant pressure combustion engine using the same propellants. The use of RDC with nitrous oxide, oxygen, and one of the fuels disclosed above may improve the specific impulse by about 2%, about 4%, about 6%, about 8%, about 10%, about 12%, or about 15% over a constant pressure combustion engine using the same propellants. The use of RDC with nitrous oxide, oxygen, and one of the fuels disclosed above may improve the specific impulse by at least about 2%, about 4%, about 6%, about 8%, about 10%, or about 12% over a constant pressure combustion engine using the same propellants. The use of RDC with nitrous oxide, oxygen, and one of the fuels disclosed above may improve the specific impulse by at most about 4%, about 6%, about 8%, about 10%, about 12%, or about 15% over a constant pressure combustion engine using the same propellants.

The specific impulse may be greater than about 0 seconds, 50 seconds, 100 seconds, 150 seconds, 200 seconds, 250 seconds, 300 seconds, 350 seconds, 400 seconds, or 450 seconds. The specific impulse may be less than about 50 seconds, 100 seconds, 150 seconds, 200 seconds, 250 seconds, 300 seconds, 350 seconds, 400 seconds, or 450 seconds. The specific impulse can be between 300 and 400 seconds.

The difference in the specific impulse between the RDC and CPC lines for similar propellants may show that a RDC can add meaningful benefits to the choice of propellants.

In some cases, as shown in FIG. 3, there may be a range of mixture values where the specific impulse of an RDC thruster is greater than a CPC thruster. The top point of the curve for both the RDC and CPC graphs is denoted with the vertical lines with arrows. The top point can indicate the mixture ratio of the oxidizer and fuel, as measured by mass, with the highest specific impulse. In some cases, this point can be the target operating mixture for a thruster. In some cases, the range of mixture values where the specific impulse of an RDC thruster is greater than a CPC thruster for a nitrous oxide/ethane RDC thruster and a nitrous oxide/ethane CPC thruster can be from about 4 to about 11. In some cases, the range of mixture values for a nitrous oxide/ethane RDC thruster can be from about 4 to about 5, about 4 to about 6, about 4 to about 7, about 4 to about 8, about 4 to about 9, about 4 to about 10, about 4 to about 11, about 5 to about 6, about 5 to about 7, about 5 to about 8, about 5 to about 9, about 5 to about 10, about 5 to about 11, about 6 to about 7, about 6 to about 8, about 6 to about 9, about 6 to about 10, about 6 to about 11, about 7 to about 8, about 7 to about 9, about 7 to about 10, about 7 to about 11, about 8 to about 9, about 8 to about 10, about 8 to about 11, about 9 to about 10, about 9 to about 11, or about 10 to about 11. In some cases, the range of mixture values for a nitrous oxide/ethane RDC thruster can be about 4, about 5, about 6, about 7, about 8, about 9, about 10, or about 11. In some cases, the range of mixture values for a nitrous oxide/ethane RDC thruster can be at least about 4, about 5, about 6, about 7, about 8, about 9, or about 10. In some cases, the range of mixture values for a nitrous oxide/ethane RDC thruster can be at most about 5, about 6, about 7, about 8, about 9, about 10, or about 11. In some cases, the range of mixture values for a nitrous oxide/ethane RDC thruster can be from about 6.3 to about 6.6. In some cases, the optimal point for a nitrous oxide/ethane RDC thruster can be from about 6.4 to about 6.5.

In some cases, the range of mixture values point for a nitrous oxide, oxygen, and ethane (or other fuel disclosed above) RDC thruster can be from about 4 to about 11 of oxidizer relative to fuel. In some cases, the range of mixture values can be from about 4 to about 5, about 4 to about 6, about 4 to about 7, about 4 to about 8, about 4 to about 9, about 4 to about 10, about 4 to about 11, about 5 to about 6, about 5 to about 7, about 5 to about 8, about 5 to about 9, about 5 to about 10, about 5 to about 11, about 6 to about 7, about 6 to about 8, about 6 to about 9, about 6 to about 10, about 6 to about 11, about 7 to about 8, about 7 to about 9, about 7 to about 10, about 7 to about 11, about 8 to about 9, about 8 to about 10, about 8 to about 11, about 9 to about 10, about 9 to about 11, or about 10 to about 11. In some cases, the range of mixture values can be about 4, about 5, about 6, about 7, about 8, about 9, about 10, or about 11. In some cases, the range of mixture values can be at least about 4, about 5, about 6, about 7, about 8, about 9, or about 10. In some cases, the range of mixture values can be at most about 5, about 6, about 7, about 8, about 9, about 10, or about 11. In some cases, the range of mixture values can be from about 6.3 to about 6.6. In some cases, the range of mixture values can be from about 6.4 to about 6.5.

In some cases, the range of mixture values for an oxidizer/fuel RDC thruster can be from about 4 to about 11. In some cases, the range of mixture values for an oxidizer/fuel RDC thruster can be from about 4 to about 5, about 4 to about 6, about 4 to about 7, about 4 to about 8, about 4 to about 9, about 4 to about 10, about 4 to about 11, about 5 to about 6, about 5 to about 7, about 5 to about 8, about 5 to about 9, about 5 to about 10, about 5 to about 11, about 6 to about 7, about 6 to about 8, about 6 to about 9, about 6 to about 10, about 6 to about 11, about 7 to about 8, about 7 to about 9, about 7 to about 10, about 7 to about 11, about 8 to about 9, about 8 to about 10, about 8 to about 11, about 9 to about 10, about 9 to about 11, or about 10 to about 11. In some cases, the range of mixture values for an oxidizer/fuel RDC thruster can be about 4, about 5, about 6, about 7, about 8, about 9, about 10, or about 11. In some cases, the range of mixture values for an oxidizer/fuel RDC thruster can be at least about 4, about 5, about 6, about 7, about 8, about 9, or about 10. In some cases, the range of mixture values for an oxidizer/fuel RDC thruster can be at most about 5, about 6, about 7, about 8, about 9, about 10, or about 11. In some cases, the range of mixture values for an oxidizer/fuel RDC thruster can be from about 6.3 to about 6.6. In some cases, the range of mixture values for an oxidizer/fuel RDC thruster can be from about 6.4 to about 6.5.

In some cases, the propellants may comprise a moderate-to high-vapor pressure liquids at normal storage temperatures, for example between about 0 -100 degrees Fahrenheit. Some of the propellants described herein, such as nitrous oxide and ethane, may have a vapor pressure of approximately 500 psi at about 0 Celsius. Some or all of the fuels mentioned herein, such as ethane, propane, n-butane, isobutane, ethylene, propylene, acetylene, ammonia, or combinations thereof, may have a moderate to high vapor pressure.

In some cases, the propellants described herein may have a vapor pressure of from about 30 psi to about 500 psi. In some cases, the propellants described herein may have a vapor pressure of from about 30 psi to about 50 psi, about 30 psi to about 75 psi, about 30 psi to about 100 psi, about 30 psi to about 150 psi, about 30 psi to about 200 psi, about 30 psi to about 300 psi, about 30 psi to about 400 psi, about 30 psi to about 500 psi, about 50 psi to about 75 psi, about 50 psi to about 100 psi, about 50 psi to about 150 psi, about 50 psi to about 200 psi, about 50 psi to about 300 psi, about 50 psi to about 400 psi, about 50 psi to about 500 psi, about 75 psi to about 100 psi, about 75 psi to about 150 psi, about 75 psi to about 200 psi, about 75 psi to about 300 psi, about 75 psi to about 400 psi, about 75 psi to about 500 psi, about 100 psi to about 150 psi, about 100 psi to about 200 psi, about 100 psi to about 300 psi, about 100 psi to about 400 psi, about 100 psi to about 500 psi, about 150 psi to about 200 psi, about 150 psi to about 300 psi, about 150 psi to about 400 psi, about 150 psi to about 500 psi, about 200 psi to about 300 psi, about 200 psi to about 400 psi, about 200 psi to about 500 psi, about 300 psi to about 400 psi, about 300 psi to about 500 psi, or about 400 psi to about 500 psi. In some cases, the propellants described herein may have a vapor pressure of about 30 psi, about 50 psi, about 75 psi, about 100 psi, about 150 psi, about 200 psi, about 300 psi, about 400 psi, or about 500 psi. In some cases, the propellants described herein may have a vapor pressure of at least about 30 psi, about 50 psi, about 75 psi, about 100 psi, about 150 psi, about 200 psi, about 300 psi, or about 400 psi. In some cases, the propellants described herein may have a vapor pressure of at most about 50 psi, about 75 psi, about 100 psi, about 150 psi, about 200 psi, about 300 psi, about 400 psi, or about 500 psi.

In some cases, the propellants can have a vapor pressure greater than about 30 psi from about 0 C to about 100 C. As the temperature increases, the pressure can increase as well. As such, a propellant with a vapor pressure about 30 psi at 0 C can also constitute a vapor pressure greater than about 30 psi at higher temperatures.

In some cases, the propellants are self-pressurizing. In some cases, the propellants can be self-pressurizing because the vapor pressure of the propellant is greater than the operating pressure. The operating pressure can be the specific pressure at which a chemical reaction or process is conducted. In other words, the operating pressure can be the pressure of the environment in which the reaction occurs. The operating pressure can be the pressure in the combustion chamber or annular chamber (as the reaction vessel). In some cases, the operating pressure may be from about 80 psi to about 120 psi. In some cases, the operating pressure may be about 100 psi. In some cases, such as at sea level, the operating pressure may be 1 atmospheric pressure (atm), which is equivalent to about 14.7 psi. In some cases, such as when the operating pressure is 14.7 psi, the vapor pressure can be about 30 or larger and be sufficient to self-pressurize. In some cases, such as when the operating pressure is about 100 psi, the vapor pressure can be over 100 psi to self-pressurize.

An additional benefit of the pressure differential between the operating pressure and the vapor pressure can be the movement of propellants. Rather than using a separate or additional mechanical or pressurant system, the pressure differential can drive the movement of the propellants to the combustion chamber from their respective tanks automatically. This can be because gases move towards the area of lower pressure when there is a pressure differentiation. As such, once a liquid self-pressurizes and becomes a gas, it can move towards the combustion chamber for combustion.

This may eliminate the need for pressurant tanks, thereby decreasing the weight and size of the thruster. This may make the system easier to operate and have fewer potential points of failure. In some cases, the system may draw on either the vapor or liquid phase in the pressurant tank, which may be alternated between to cool the chamber or for injection into the chamber.

Detonation may not be achievable for all propellants. A lower thrust, and thus lower chamber pressure, may be used because detonation may be more stable at these conditions. The injector design may also play a role in mixing the reactants to prepare for the detonation wave. The injector may enhance detonation strength.

### Thruster

Described herein are high-efficiency satellite thrusters. The thrusters may comprise a rotation detonation combustion (RDC) chamber. The thrusters may comprise an igniter, a combustion chamber, a cooling system, a manifold, an injector, a nozzle, a propellant feed system, or any combination thereof. The thrusters may have a propellant source operably coupled to the RDC chamber. The thrusters may be bipropellant or monopropellant. The thrusters may comprise a valve system to control a feed of one or more chemical propellants to the combustion chamber. In some cases, the valve system may draw on either a vapor or liquid phase of one or more chemical propellants as described herein. The valve system may alternate between two or more chemical propellants to cool the combustion chamber or for injection into the chamber. The valve system may alternate between two chemical propellants as described above.

In some cases, there are variable ignition sources that may be used. In some cases, there are five or more ignition sources that may be used. The ignition source may be a spark plug mounted normal to the combustion chamber. A spark box mounted elsewhere on the system may provide a high voltage to the spark plug, which may arc through the chamber to the inner wall to provide ignition energy. The ignition source may be a pre-detonator mounted normal or tangential to the chamber wall. The ignition source may be a flame torch mounted normal or tangential to the chamber wall. The ignition source may be a catalytic decomposition of one or more of the propellants described herein. The ignition source may be a catalytic decomposition of one or more of the oxidizers. A catalyst bed may be placed in line with either of the propellant feed system, or other propellant feed system, to exothermically decompose it. Exothermal catalytic decomposition may provide energy for ignition. If the catalyst bed design is used, the thruster may be used in a monopropellant design by decomposing the oxidizer (e.g., nitrous oxide) due to its low thrust, low specific impulse. If the catalyst bed design is used, the thrust may also use bipropellant mode. The catalyst bed may comprise stacked screens. The catalyst bed may comprise of a packed bed of coated spherical beads. The catalyst bed may comprise meshes comprising a coating. The coating material can comprise one or more of noble metals, bare oxides, hexaaluminates, hydrotalcites, spinels, perovskites, mixed metal oxides, or any combination thereof. The ignition source may be injection of TEA-TEB (triethyl aluminum-triethyl borane) into the chamber. The ignition source could be a combination of the above methods.

In some cases, the hardware may comprise the physical thruster. The physical thruster may be partially or fully additively manufactured. Additive manufacturing can comprise one or more of 3D printing, Selective Laser Melting (SLM), Direct Selective Laser Sintering (DSLS), Direct Metal Laser Melting (DMLM), Laser Net Shape Manufacturing (LNSM), Direct Metal Deposition (DMD), Fused Deposition Modeling (FDM), Selective Laser Sintering (SLS), Laser Engineered Net Shaping (LENS), Direct Selective Laser Melting (DSLM), Stereolithography (SLA), Electron Beam Sintering (EBS), Electron Beam Melting (EBM), Digital Light Processing (DLP), or any combination thereof.

The physical thruster may be partly or fully additively manufactured of one or more materials. Potential materials may include a ceramic, a ceramic matrix composite (CMC), a copper-based alloy, a steel-based alloy, a nickel-based alloy, a niobium-based alloy, a superalloy (e.g., an alloy with a high oxidation resistance), or combinations thereof. The CMC may comprise carbon/carbon (C/C) or carbon/silica carbide (C/SiC). The copper alloy may comprise GR-Cop 42 or GR-Cop 84. The nickel-based alloy may comprise Inconel 625, Inconel 718, Monel, Hastelloy, GRX-18, HR-1. The niobium-based alloy may comprise C-103.

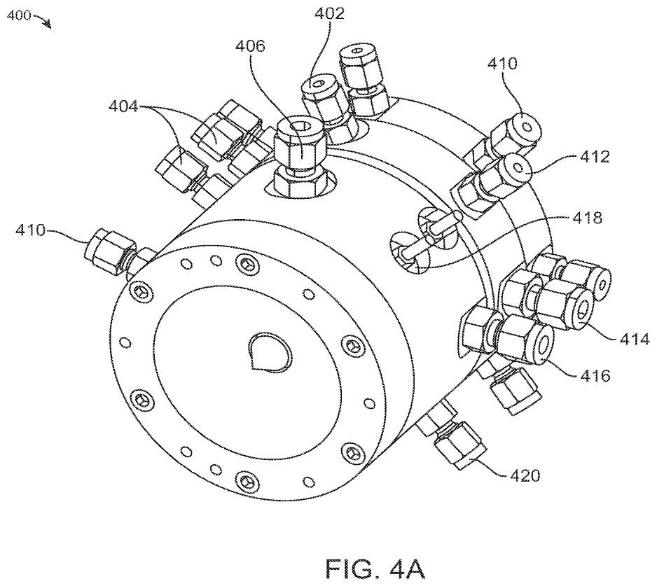

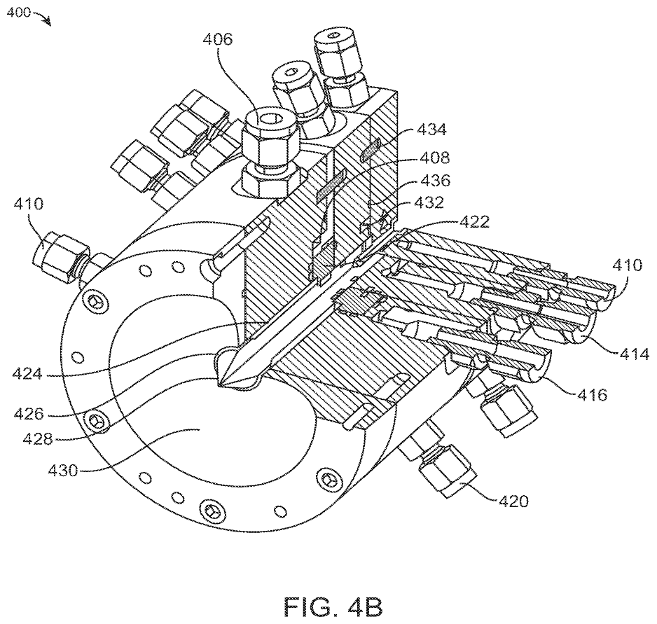

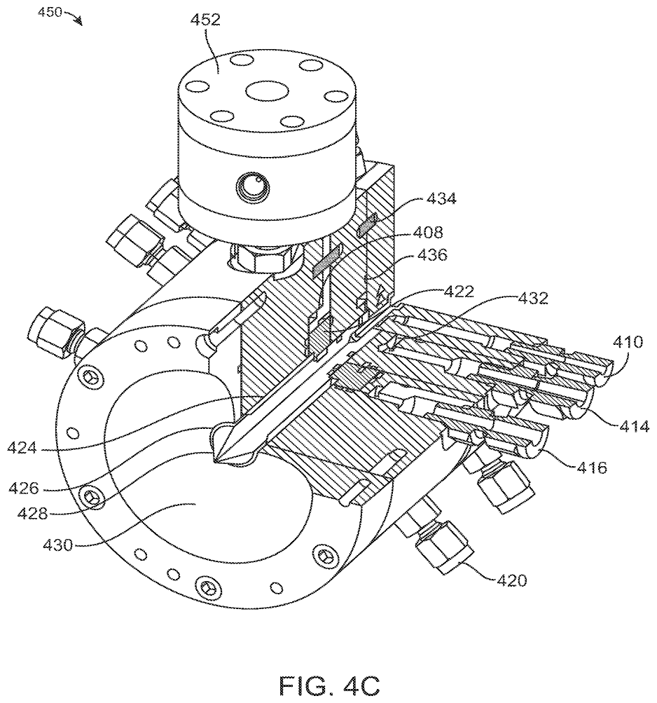

FIGS. 4A-4C illustrate perspective and cross-sectional views of an example thruster 400. Thruster 400 can comprise propellant manifold temperature port 402, propellant manifold pressure port 404, ignition system integration interface 406, propellant manifold and injector housing 408, base drag ports (e.g., pressure measurement ports) 410, relief port 412, first propellant inlet 414, second propellant inlet 416, high frequency sensors 418, chamber pressure port 420, injector 422, annular chamber (e.g., combustion chamber) 424, annular throat 426, aerospike 428, nozzle shroud 430, propellant manifold 432, alignment pins 434, and sealing features 436. FIG. 4C shows the thruster with igniter 450 comprising propellant manifold and injector housing 408, base drag ports (e.g., pressure measurement ports) 410, first propellant inlet 414, second propellant inlet 416, chamber pressure port 420, injector 422, annular chamber 424, annular throat 426, aerospike 428, nozzle shroud 430, propellant manifold 432, alignment pins 434, sealing features 436, and torch igniter 452.

In some cases, there are various combustion chamber designs. The chamber may comprise an acoustically resonant chamber. The chamber may be annular, with an outer body and inner centerbody. The annular shape may encourage the formation and stability of the detonation waves. For example, the annular design can create a track for a detonation wave to travel. Chamber design variations may include a straight chamber, a chamber that tapers outward, a chamber that tapers inward, or any combination thereof. For example, the chamber may comprise an annulus that tapers outward, that tapers inward, or any combination thereof. The chamber may or may not have a geometric throat (e.g., combustor throat or annular throat 426), where the cross-sectional area reaches a minimum. The geometric throat 426 may or may not be used to increase the pressure in the chamber. The narrowing of space in the annular chamber 424 as it approaches the throat 426 can be used to constrict or choke the flow of gas. When combustion creates thermal energy in the annular chamber, constricting the flow of the gas and combustion can convert the thermal energy to kinetic energy by accelerating the flow to a supersonic speed. The kinetic energy can help to efficiently and effectively propel the satellite (or other system using the thruster).

As the annular chamber and thruster can experience high and fluctuating pressures, as well as variable temperatures at rest and during activation both in the atmosphere and in space, it can be beneficial to monitor the pressure and temperature at various parts of the thruster. For this reason, the thruster can comprise multiple temperature and pressure ports disposed on various parts of the thruster. This can include propellant manifold temperature port(s) 402, which can comprise 1 or multiple temperature ports to monitor temperature in various sections of the manifold of the oxidizer the fuel (e.g., the propellants), or both. There can also be propellant manifold pressure port(s) 404, which can comprise 1 or more pressure ports to monitor pressure in various sections of the manifold of the oxidizer the fuel (e.g., the propellants), or both. This can include the ports to manifold 432, which can comprise a propellant manifold such as an oxidizer manifold, or fuel manifolds. Manifolds themselves can be networks of piping or tubes to distribute fluids (e.g., liquids, gases, or both) throughout the thruster system.

The base drag ports 410 may likewise be used to measure pressure. Ports 410 can measure the pressure on the nozzle. The chamber pressure port(s) 420 can also comprise one or more pressure ports. The chamber pressure port(s) 420 can lead out of the annular chamber 424 to monitor the build-up of pressure in the combustion chamber 424.

In some cases, there can be a port 406 that can act as an interface for ignition system integration. This port 406 can facilitate fluid communication between the ignition system, such as torch ignitor 452, and the remainder of the RDC thruster.

In some cases, there may be at least one temperature port, at least one pressure port, or both fluidically connected to the ignitor. In some cases, the ports can measure a state (e.g., pressure, temperature, or both) of a propellant before it is injected or the operating conditions where the propellant will be injected.

In some cases, relief port 412 can relieve pressure buildup.

In some cases, there can be one or more propellant inlets from propellant tanks to the annular chamber 424. In some cases, for example in monopropellant thrusters, all propellant inlets can convey the same propellant. In some cases, for example in bipropellant thrusters, different propellant inlets can convey different propellants. In some cases, a first propellant inlet 414 can convey a fuel or an oxidizer. In some cases, the second propellant inlet 416 can convey a fuel or an oxidizer. In some cases, there may be 1, 2, 3, 4, 5, or more propellant inlets of each type. In some cases, there are more inlets of one type than the other. In some cases, there are the same number of inlets of both types. In some cases, first propellant inlet 414 and second propellant inlet 416 can convey the same propellant. In some cases, they can convey different propellants to the annular chamber 424. The fuel propellant can comprise one or more of ethane, propane, n-butane, isobutane, ethylene, propylene, acetylene, ammonia, or combinations thereof. The oxidizer propellant can comprise nitrous oxide, nitrous oxide with oxygen, or other oxidizers. The propellant inlets can measure one or more of pressure, temperature, or quantity of the fluid being conveyed to the annular chamber 424.

In some cases, the thrusters can comprise high frequency sensors 418. The high frequency sensors 418 can comprise pressure sensors. The high frequency sensors 418 can comprise piezoelectric pressure sensors. The pressure sensors can sense and convert pressure into an analog electrical signal. A piezoelectric pressure sensor can measure small pressure fluctuations at high static pressure levels. This can be helpful in high-pressure environments like the combustion chamber 424. The sensors can be used to measure instantaneous dynamic pressure as a diagnostic for the strength and coherency of the RDC wave.

In some cases, the RDC process may produce higher specific impulses by utilizing the higher combustion efficiency of detonation. A detonation may be a supersonic combustion wave composed of a leading shock supported by a trailing reaction zone. The leading shock may increase the pressure of the reactants by from about 2 to about 30 times their injected pressure, where it is then burned by the reaction zone. The pressure at which the reactants are burned may directly increase the combustion efficiency, leading to higher work extraction for the same propellant mass flow.

In some cases, the manifolds and injector 422 deliver propellant into the combustion chamber 424. The chamber 424 may be designed to handle the high-pressure detonation wave and associated acoustics. The injector 422 may be used to inject fluids of interest into the combustion chamber 424, mix them, and promote detonation, or any combination thereof. The injector 422 can be used to inject the fuel and oxidizer, such as those discussed above, into the combustion chamber 424 and to mix the fuel and oxidizer to create the combustion reaction.

The manifolds and injector 422 can have a housing 408 surrounding them. In some cases, these manifolds can be the oxidizer manifolds. In some cases, these manifolds can be the fuel manifolds.

In some cases, the nozzle is a de Laval nozzle, an aerospike nozzle, a shrouded aerospike nozzle, or an expansion deflection nozzle. The nozzle may be an aerospike nozzle 428, where an expansion cone or spike may be attached to the end of the centerbody. The tip of the spike may be truncated, and a small amount of unburned propellant may flow through the tip for cooling. The nozzle may be a shrouded aerospike nozzle. In some cases, the outer portion of the nozzle may be similar to a de Laval nozzle and may extend beyond the spike to achieve a useful or predetermined nozzle expansion ratio. The exact contours of these two surfaces may be designed for perfect expansion of the detonation exhaust flow. The nozzle may be a de Laval nozzle where a centerbody spike may or may not be omitted. The nozzle may be an expansion deflection nozzle where the centerbody is contoured radially outward to expand the flow against an outer shroud to achieve full expansion. In some cases, the nozzle is partially or fully printed.

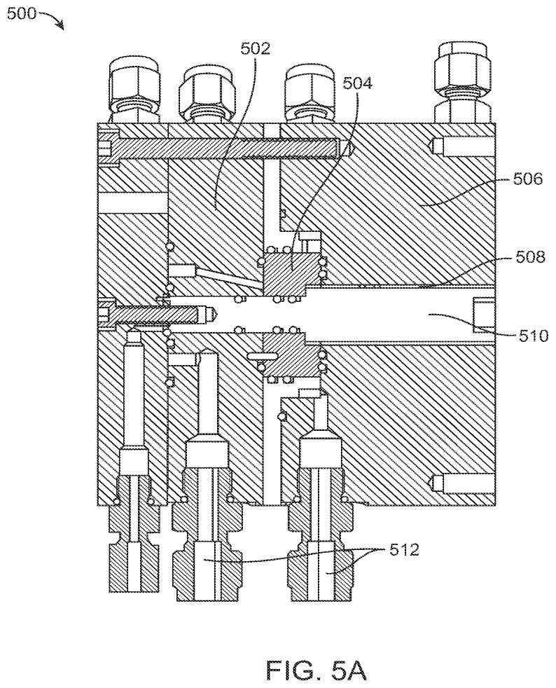

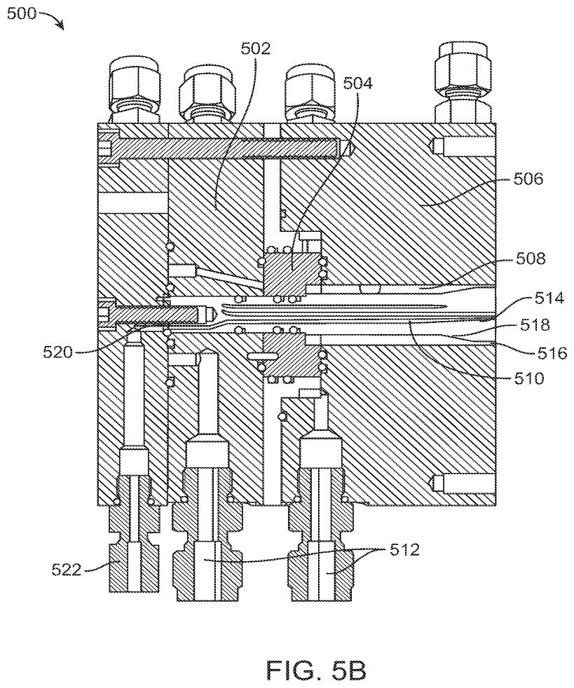

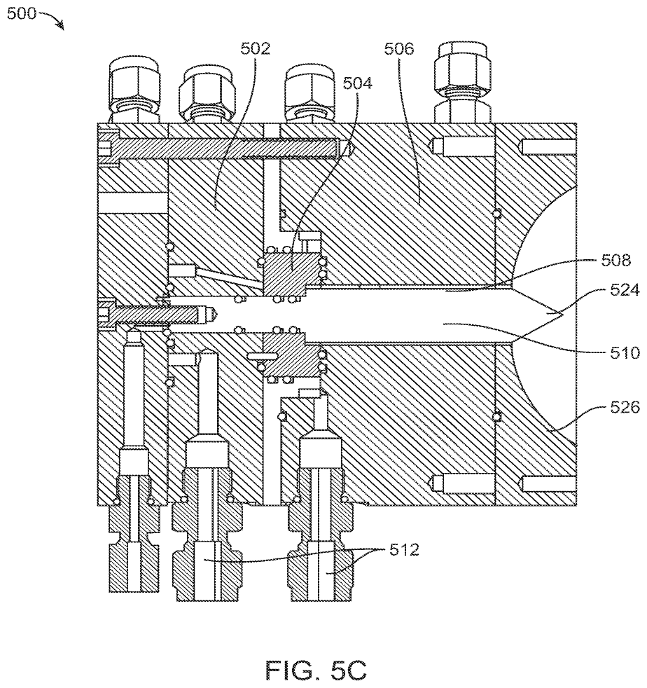

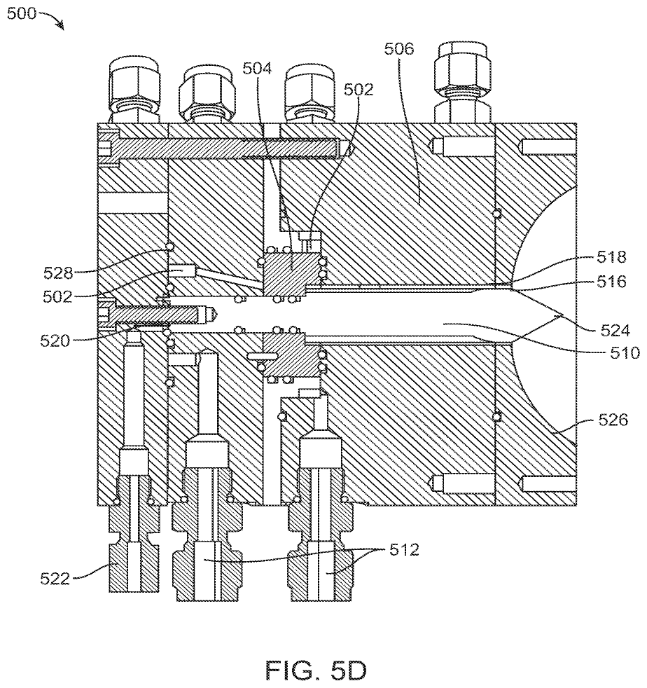

In some cases, the thruster disclosed herein can comprise an aerospike 428. The thruster can comprise a nozzle shroud 430. When there is an aerospike 428 without the shroud, the thruster can comprise an aerospike nozzle. An aerospike nozzle 428 can be beneficial for an RDC thruster due to an inherent ability to adjust to a range of operating pressures. Additionally, the aerospike nozzle design 428 can capture pressure waves and thrust more efficiently than other nozzles due to fluid dynamics effects. When there is an aerospike 428 with the nozzle shroud 430, the thruster can comprise a shrouded aerospike nozzle. For example, FIG. 4B can depict a cross-section of a shrouded aerospike nozzle profile. As shown in FIGS. 4B-4C and 5C-5D, the nozzle shroud 430 (and counterpart in device 500) can surround the aerospike nozzle 428. This can improve the thrust efficiency by directing the flow of gas and kinetic energy more effectively. In some cases, the nozzle shroud 430 can protect the aerospike from debris.

In some cases, there can be a number of features for stabilization of the various parts of the thruster. These features can include alignment pins 434 and sealing features 436. Alignment pins 434 can be pins disposed between sections or joints of the inner part of the outerbody of the thruster. Sealing features 436 can comprise o-ring seals. The o-rings 436 can seal volumes of fluid from each other. For example, they can be specially designed for nitrous oxide.

The thruster may comprise a cooling unit. The cooling unit may be configured to cool the RDC chamber. The cooling unit may be configured to cool the nozzle. The cooling unit may cool a portion of the RDC. The cooling unit may cool a throat of the nozzle. The cooling unit may be configured to cool the geometric throat of the nozzle. In some cases, there are various cooling designs. In some cases, the cooling design comprises full regenerative cooling with the fuel, the oxidizer, or both. This may include the full chamber and nozzle. The regenerative cooling loop may be used to pressurize (e.g., self-pressurize) one or both of the fuel and the oxidizer. In some cases, the cooling design may comprise regenerative cooling of a portion of the chamber and nozzle throat, with a printed nozzle of a material suitable for radiative cooling. In some cases, the cooling unit comprises a fully printed design of the radiative cooling material. In some cases, the cooling unit may be configured for partial regenerative cooling. The cooling unit can be configured for radiative cooling. Radiative cooling may refer to simply allowing heat to escape from a hot surface by emitting infrared radiation into space. Regenerative cooling may refer to actively cooling the thruster by circulating the propellant through channels (feed systems, manifold) thereby allowing the propellant to absorb heat before being injected into the chamber.

In some cases, the rotating detonation combustion chamber, the nozzle, or both comprise a superalloy or a ceramic configured to radiatively cool the rotating detonation combustion chamber, the nozzle, or both. In some cases, the rotating detonation combustion chamber, the nozzle, or both comprise a metal-based structure configured to regeneratively cool the rotating detonation combustion chamber, the nozzle, or both.

The thruster system 450 using elements of thruster 400 may comprise an ignitor to ignite the propellant gas and create thrust. The ignitor can comprise a torch igniter 452.

FIGS. 5A-5D shows open, laid-flat schematics of a thruster 500. Thruster 500 can comprise manifolding 502, injector 504, outerbody 506, annular chamber 508, centerbody 510, propellant inlet ports (e.g., oxidizer and fuel) 512, base drag ports (e.g., pressure measurement ports) 514, combustor throat 516, chamber contraction 518, gasket 520, connection to base drag pressure sensors 522, aerospike 524, nozzle shroud 526, and o-ring seals 528 (e.g., sealing features). Thruster 500 can be similar to thrust 400 and can have some or all of the features described above.

In some cases, there are various combustion chamber designs. The chamber may comprise an acoustically resonant chamber. The chamber may be annular, with an outer body and inner centerbody. The annular shape may encourage the formation and stability of the detonation waves. For example, the annular design can create a track for a detonation wave to travel. Chamber design variations may include a straight chamber, a chamber that tapers outward, a chamber that tapers inward, or any combination thereof. For example, the chamber may comprise an annulus that tapers outward, that tapers inward, or any combination thereof. The chamber may or may not have a geometric throat (e.g., combustor throat or annular throat 516), where the cross-sectional area reaches a minimum after a contracting portion 518 of the annular chamber 508. The geometric throat 516 may or may not be used to increase the pressure in the chamber. The narrowing of space in the annular chamber 508 as it approaches the throat 516 can be used to constrict or choke the flow of gas. When combustion creates thermal energy in the annular chamber, constricting the flow of the gas and combustion can convert the thermal energy to kinetic energy by accelerating the flow to a supersonic speed. The kinetic energy can help to efficiently and effectively propel the satellite (or other system using the thruster).

In some cases, the centerbody 510 can form the annular chamber 508. In some cases, the outerbody 506 can form the larger layer of the thruster where the manifold 402 and various ports proceed through. The external-facing side of the outerbody 506 can comprise the external side of the thruster.

As the annular chamber and thruster can experience high and fluctuating pressures, as well as variable temperatures at rest and during activation both in the atmosphere and in space, it can be beneficial to monitor the pressure and temperature at various parts of the thruster. For this reason, the thruster can comprise multiple temperature and pressure ports disposed on various parts of the thruster. This can include the ports to manifold 502, which can comprise a propellant manifold such as an oxidizer manifold, or fuel manifolds. Manifolds themselves can be networks of piping or tubes to distribute fluids (e.g., liquids, gases, or both) throughout the thruster system.

The base drag ports 514 make likewise be used to measure pressure. Ports 514 can measure the pressure on the nozzle. The thruster can comprise connections to the base drag pressure sensors 522.

In some cases, there may be at least one temperature port, at least one pressure port, or both fluidically connected to the manifolds. In some cases, the ports can measure a state (e.g., pressure, temperature, or both) of a propellant before it is injected or the operating conditions where the propellant will be injected.

In some cases, there can be one or more propellant inlets from propellant tanks to the annular chamber 508. In some cases, for example in monopropellant thrusters, all propellant inlets can convey the same propellant. In some cases, for example in bipropellant thrusters, different propellant inlets can convey different propellants. In some cases, a first propellant inlet 512 can convey a fuel or an oxidizer. In some cases, the second propellant inlet 512 can convey a fuel or an oxidizer. In some cases, there may be 1, 2, 3, 4, 5, or more propellant inlets of each type. In some cases, there are more inlets of one type than the other. In some cases, there are the same number of inlets of both types. In some cases, first propellant inlet 512 and second propellant inlet 512 can convey the same propellant. In some cases, they can convey different propellants to the annular chamber 508. The fuel propellant can comprise one or more of ethane, propane, n-butane, isobutane, ethylene, propylene, acetylene, ammonia, or combinations thereof. The oxidizer propellant can comprise nitrous oxide, nitrous oxide with oxygen, or other oxidizers. The propellant inlets can measure one or more of pressure, temperature, or quantity of the fluid being conveyed to the annular chamber 508.

In some cases, the manifolds and injector 504 deliver propellant into the combustion chamber 508. The chamber 508 may be designed to handle the high-pressure detonation wave and associated acoustics. The injector 504 may be used to inject fluids of interest into the combustion chamber 508, mix them, and promote detonation, or any combination thereof. The injector 504 can be used to inject the fuel and oxidizer, such as those discussed above), into the combustion chamber 508 and to mix the fuel and oxidizer to create the combustion reaction.

In some cases, the nozzle is a de Laval nozzle, an aerospike nozzle, a shrouded aerospike nozzle, or an expansion deflection nozzle. The nozzle may be an aerospike nozzle 524, where an expansion cone or spike may be attached to the end of the centerbody. The tip of the spike may be truncated, and a small amount of unburned propellant may flow through the tip for cooling. The nozzle may be a shrouded aerospike nozzle. In some cases, the outer portion of the nozzle may be similar to a de Laval nozzle and may extend beyond the spike to achieve a useful or determined nozzle expansion ratio. The exact contours of these two surfaces may be designed for perfect expansion of the detonation exhaust flow. The nozzle may be a de Laval nozzle where a centerbody spike may or may not be omitted. The nozzle may be an expansion deflection nozzle where the centerbody is contoured radially outward to expand the flow against an outer shroud to achieve full expansion. In some cases, the nozzle is partially or fully printed.

In some cases, the thruster disclosed herein can comprise an aerospike 524. The thruster can comprise a nozzle shroud 526. When there is an aerospike 524 without the shroud, the thruster can comprise an aerospike nozzle. An aerospike nozzle 524 can be beneficial for an RDC thruster due to an inherent ability to adjust to a range of operating pressures. Additionally, the aerospike nozzle design 524 can capture pressure waves and thrust more efficiently than other nozzles due to fluid dynamics effects. The centerbody 510 can be used to form or support the aerospike 524.

When there is an aerospike 524 with the nozzle shroud 526, the thruster can comprise a shrouded aerospike nozzle. For example, FIGS. 5C-5D can depict a cross-section of a shrouded aerospike nozzle profile. As shown in FIGS. 5C-5D, the nozzle shroud 526 (and counterpart in device 500) can surround the aerospike nozzle 524. This can improve the thrust efficiency by directing the flow of gas and kinetic energy more effectively. In some cases, the nozzle shroud 526 can protect the aerospike from debris.

In some cases, there can be a number of features for stabilization of the various parts of the thruster. These features can include sealing features 528. Sealing features 528 can comprise o-ring seals. The o-rings 528 can seal volumes of fluid from each other. For example, they can be specially designed for nitrous oxide. Gasket 520 can help to hold and stabilize the centerbody 510 in the thruster. Likewise, gasket 520 can also provide sealing functionality at the proximal (opposite from nozzle) end of the thruster.

The thruster may comprise a cooling unit. The cooling unit may be configured to cool the RDC chamber. The cooling unit may be configured to cool the nozzle. The cooling unit may cool a portion of the RDC. The cooling unit may cool a throat of the nozzle. The cooling unit may be configured to cool the geometric throat of the nozzle. In some cases, there are various cooling designs. In some cases, the cooling design comprises full regenerative cooling with the fuel, the oxidizer, or both. This may include the full chamber and nozzle. The regenerative cooling loop may be used to pressurize (e.g., self-pressurize) one or both of the fuel and the oxidizer. In some cases, the cooling design may comprise regenerative cooling of a portion of the chamber and nozzle throat, with a printed nozzle of a material suitable for radiative cooling. In some cases, the cooling unit comprises a fully printed design of the radiative cooling material. In some cases, the cooling unit may be configured for partial regenerative cooling. The cooling unit can be configured for radiative cooling. Radiative cooling may refer to simply allowing heat to escape from a hot surface by emitting infrared radiation into space. Regenerative cooling may refer to actively cooling the thruster by circulating the propellant through channels (feed systems, manifold) thereby allowing the propellant to absorb heat before being injected into the chamber.

In some cases, the rotating detonation combustion chamber, the nozzle, or both comprise a superalloy or a ceramic configured to radiatively cool the rotating detonation combustion chamber, the nozzle, or both. In some cases, the rotating detonation combustion chamber, the nozzle, or both comprise a metal-based structure configured to regeneratively cool the rotating detonation combustion chamber, the nozzle, or both.

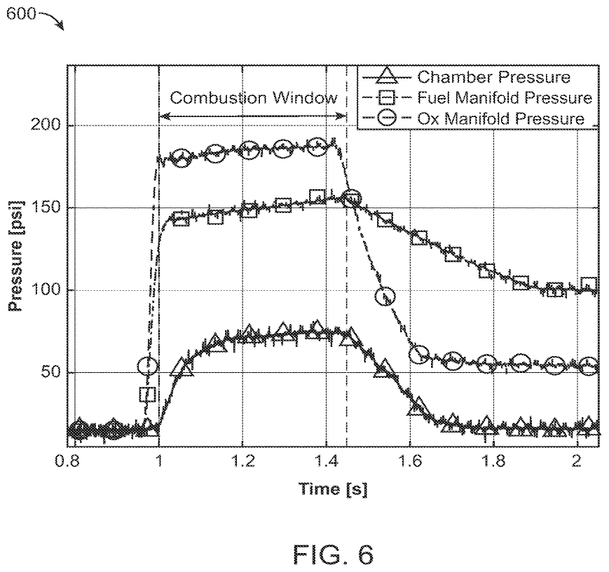

FIG. 6 illustrates a graph 600 of the combustion window as a matter of time and pressure. The y-axis denotes pressure in terms of psi. The x-axis denotes time in terms of seconds. These pressure values were actual measurements from the thruster ports during combustion. The top line represented with circles can denote the oxidizer manifold pressure. The oxidizer can comprise nitrous oxide, a mix of nitrous oxide and oxygen, or another type of oxidizer. The middle line represented with squares can denote the fuel manifold pressure. The fuel can comprise ethane, propane, n-butane, isobutane, ethylene, propylene, acetylene, ammonia, or combinations thereof. The lowest line represented with triangles denotes the chamber pressure. The time between the vertical dashed lines, between 1 s and about 1.45 s, denotes the combustion window. As discussed above, the fuel and oxidizer can have a high vapor pressure and can self-pressurize. They can be driven from areas of high pressure (their tanks) to areas of lower pressure (the chamber) through the manifold, resulting in manifold pressures greater than the chamber pressure. In short, pressure in multiple areas of the thruster system can sharply increase during combustion, providing the thermal and kinetic energy for thruster propulsion.

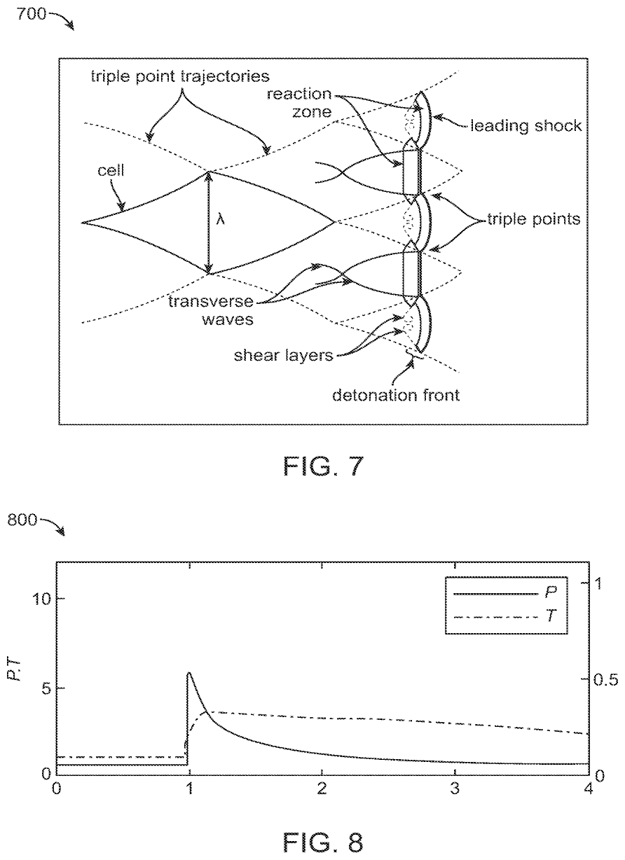

FIG. 7 illustrates a two-dimensional schematic of a detonation wave and cell-structure 700. In decreasing the size of the RDC thrusters, the physics of detonation may be considered.

On a micro-scale, a detonation wave can be composed of small 3-D cell-like structures, as shown in FIG. 7. The stability and strength of the detonation wave may depend on two features: the propellants and physical size of the hardware. The combustion chamber may be large enough to support an integer multiple of detonation cells, which can be a function of the combustion chemistry via the propellant choice.

FIG. 8 depicts flow field stimulation results 800, including pressure, temperature, and combustion progress, using a Euler-equations based RDC model. A method employing the Euler equations for inviscid, compressible flow may be used in place of computational fluid dynamics models using second-order accuracy in time and space. The x-axis can represent time. The graph can represent the pressure-temperature at a specific physical point in the combustion chamber. The pressure-temperature point may change over time because of the detonation wave. The solid line represents pressure, and the dotted line represents temperature.

FIG. 9 shows image stills 900 from a high-speed video looking axially upstream at the combustion chamber, where the illumination shows the combustion and the heightened brightness shows the presence of the detonation wave. The experiment and recording of FIG. 9 was done at the optimum mixture ratio identified in FIG. 1B and the pressure measurements of FIG. 6. Detonation behavior may be measured in two ways. One method can be via a high-speed videography of the back end of the chamber via a camera or other recording device. The high-speed video may be used to capture broadband chemiluminescence emitted by the detonation waves, which may be used to determine wave number, wave speed, direction, and coherency, as shown in FIG. 9. The other method can be pressure monitoring. High-frequency pressure measurements on the propellant feed system may be used to measure the pressure field generated by the detonation and may be used to assess the detonation pressure ratio. FIG. 9 shows the motion of the detonation wave 902 around the barrel of the RDC thruster (e.g., the annular combustion chamber) at various times measured in microseconds. The arrows show the circular progression of the detonation wave, which is also shown in the brighter area around the circumference of each circle. Although FIG. 9 shows one wave, there can be 1, 2, 3, 4, 5, 6, 7, 8, 9, 10, or more detonation waves. The can occur simultaneously or offset from one another. The waves can either rotate in the same direction or rotate counter to each other. The waves can rotate clockwise or counterclockwise.

### System

The thrusters described above may comprise a propellant feed system to control a feed of one or more chemical propellants to the combustion chamber. In some cases, the propellant feed system may draw on either a vapor or liquid phase of one or more chemical propellants as described herein. The propellant feed system may alternate between two or more chemical propellants to cool the combustion chamber or for injection into the chamber. The valve system may alternate between two chemical propellants as described above.

Described herein is a system comprising one or more propellant tanks, actuated valves, pressure regulators, check valves, filters, metering devices or any combination thereof. In some cases, there are two propellant tanks-this may be the bipropellant version of the thruster and system. The two propellant tanks may be separate. The two propellant tanks may hold the fuel and oxidizer. There may be greater than two propellant tanks. In some cases, one or more draw systems may be used to extract either liquid or vapor from the propellant tanks. In some cases, two draw systems may be used to extract either liquid or vapor from the propellant tanks. The actuated valves may be used to isolate the fluids from the rest of the system.

FIG. 10 illustrates a graphical diagram of an example of plumbing and instrumentation of propellant feed systems 1000 in an example of thrusters and systems described herein. The thruster system 1000 can comprise one or more major systems. The thruster system 1000 can comprise 1, 2, 3, or more major systems. The major systems can include one or more of an oxidizer feed system 1018, a fuel feed system 1032, and the RDC thruster 1034 itself. The RDC thruster 1034 can comprise thruster 400, 450, 500, or combinations thereof. The oxidizer feed system 1018 can comprise oxidizer tank 1002, pressure transducers 1004, thermocouples 1006, oxidizer isolation valves 1008, oxidizer pressure regulators 1010, oxidizer fill valves 1012, oxidizer flow meters 1014, and oxidizer run valves 1016. The fuel feed system 1032 can comprise fuel tank 1020, pressure transducers 1004, thermocouples 1006, fuel isolation valves 1022, fuel pressure regulators 1024, fuel fill valves 1026, fuel flow meters 1028, and fuel run valves 1030. The RDC thruster system 1034 can comprise high-frequency dynamic pressure 1036, pressure transducers 1004, thermocouples 1006, manifold 1038, injector 1040, chamber 1042, igniter 1044, and nozzle 1046.

FIG. 10 depicts a plumbing and instrumentation diagram of propellant feed systems. FIG. 10 shows a block diagram of an experimental set-up including the thruster. In some case, thruster activity may be recorded with a high-speed camera to achieve images such as FIG. 9.

In some cases, the tanks 1002 and 1020 can be storage tanks of the oxidizer and fuel, respectively. Within the tank, gas can naturally migrate up and liquid can stay in the lower part when on the Earth (e.g., subject to gravity). When in space, there can be less of a division between the space occupied by the gas and the liquid. Accordingly, in some cases, it may be desirable to have a tank that can separate the gas and the liquid or otherwise control which of the two forms is being sucked into the tubes and manifold. In other words, the tank design may allow control of where the liquid and its gaseous vapor exist in the tank to reliably pull on one or the other form. This can be achieved via surface tension, inflating devices, and other methods.

FIG. 10 shows a bipropellant version of the devices and systems described herein. Each propellant may have a pressure transducer to measure pressure 1004. Each propellant may have a thermocouple 1006 to measure temperature. Prior to reaching the thruster, each propellant goes through a series of additional valves and regulators. In some cases, the additional valves and regulators may comprise one or more of an isolation valve, a pressure regulator, a sonic venturi, a run valve, a second pressure transducer 1004, and a second thermocouple 1006, or any combination thereof for each of the oxidizer and the fuel. In some cases, the systems may not have a pressure transducer 1004. In some cases, the systems may not have thermocouples 1006. In some cases, the second pressure transducer 1004 may be used to measure pressure after a propellant has gone through the isolation valve, pressure regulator, and a metering device. In some cases, the second thermocouple 1006 may be used to measure pressure after a propellant has gone through the isolation valve, pressure regulator, and a metering device. The pressure regulators 1010 and 1024 may regulate the pressure of the propellant. The isolation valves 1008 and 1022 may comprise an actuated valve configured to isolate the propellant in the feed system. The metering devices 1014 and 1028 may be used to control and measure the flow of the propellant. The actuated run valves 1016 and 1030 may direct flow. The actuated run valves may direct flow based on a particular flow setting, as dictated by a user, as related to particular performance, etc. Fill valves 1012 and 1026 can be used to fill the oxidizer or fuel tanks. A check valve may be used to prevent backflow. Filters may be used to prevent unwanted debris from entering the combustion chamber. Both the oxidizer feed system 1018 and the fuel feed system 1032 can comprise these regulators, meters, valves, or any combination thereof. In some cases, there are no pressure transducers or thermocouples.

In some cases, the selection of valves, including the isolation valves 1008 and 1022, fill valves 1012 and 1026, run valves 1016 and 1030, or any combination thereof can be used to control the relative amounts of the oxidizer(s) and fuel to reach an optimum mixture point as in FIG. 1B or any other relative propellant amount. These valves can also be used to isolate a propellant. In this way, the valves can allow the system to selectively draw on either the oxidizer or the fuel. The system may selectively draw based upon a set value associated with a particular fuel ratio, a set value associated a performance metric, etc. This way, even in a bipropellant system, the valves can be used to establish monopropellant functioning if desired.

In addition to controlling the propellant use, the valves can control the phase use. For example, the valve system can be used to selectively draw on either a vapor or a liquid phase of the propellants. The phase can be the same or different between the oxidizer and fuel, as they comprise separate feed systems. This can be assisted by the structure of the tanks to separate and control use of gas versus liquid phases of the propellant, as described above.

Before being driven to the manifolds, each propellant may be measured by a third set of pressure transducers, thermocouples, or both. The manifold may comprise high-frequency dynamic pressure that pressurizes the propellants. Once pressurized, the manifold may move the propellants into the injector, which mixes the propellants. The injector may inject the mixed propellants into the combustion chamber, which may then feed into the nozzle. There may be additional pressure transducers 1004 measuring the pressure in the combustion chamber and nozzle. In some cases, there is one additional pressure transducer. There may be 1, 2, 3, 4, 5, or more pressure transducers 1004 measuring the pressure in the combustion chamber and nozzle. There may be seven or more different pressure transducers. 1004 There may be more than 7 pressure transducers 1004 measuring the pressure in the combustion chamber and nozzle.

Likewise, there may be thermocouples 1006 in the oxidizer feed system 1018, the fuel feed system 1032, and the RDC system 1034. There may be 1, 2, 3, 4, 5, or more thermocouples 1006 measuring the temperature in the combustion chamber and nozzle. There may be 8 or more different thermocouples. 1006 In some cases, there are no pressure transducers or thermocouples.

The pressure transducers and thermocouples can measure pressure and temperature, respectively, of the propellant tanks by being disposed in, proximate to, or fluidically coupled to the tanks. The pressure transducers and thermocouples can measure pressure and temperature partway through the feed systems after the isolation valve and pressure regulator but before the fill valve, flow meter, and run valve. In some cases, the order of the valves, meters, and regulators may be different, and the pressure transducers and thermocouples can be disposed in different locations relative to the valves, meters, and regulators.

In the RDC system 1034, the oxidizers and fuels feed into the thruster at or via the manifold 1038. They can then be mixed and injected by the injector 1040 into the combustion chamber 1042, which can receive an ignition spark from igniter 1044, thereby creating the detonation wave and thrust which is ejected through the nozzle 1046. Throughout this process, there can be pressure transducers and thermocouples disposed along the RDC thruster and especially the nozzle to monitor pressure and temperature of the combustion.

In the RDC system 1034, high-frequency dynamic pressure 1036 can comprise the pressure from the fluid in the fuel and oxidizer manifolder. In some cases, there may be temperature and pressure measuring devices to monitor the fluid and pressure.

### Methods

Provided herein are methods for generating a detonation in a rotating detonation combustion chamber. Generating a detonation in a rotating detonation combustion engine can comprise providing an RDC thruster and propellants.

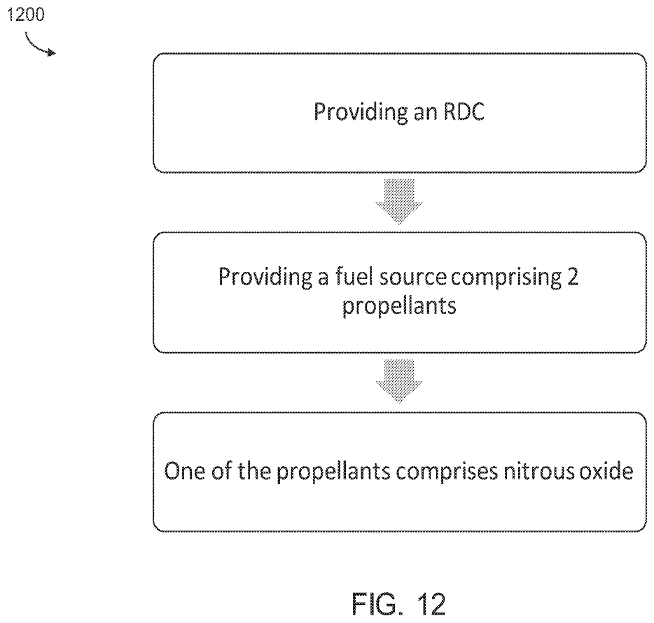

The propellants can comprise an oxidizer and a fuel. The oxidizer can comprise nitrous oxide, nitrous oxide and oxygen, or another oxidizer that provides sufficient oxygen into the system for a reaction. The fuel can comprise ethane, propane, n-butane, isobutane, ethylene, propylene, acetylene, ammonia, or combinations thereof. The fuels and oxidizers can be self-pressurizing such that their liquid phase's vapor pressure is greater than their operating pressure, as defined and described above and shown in FIG. 11. Accordingly, the method 1100 to generate a detonation can comprise providing an RDC thruster and two chemical propellants, wherein each propellant comprises a liquid with a vapor pressure greater than the operating pressure. As shown in the method 1200 of FIG. 12, one of the two chemical propellants can comprise nitrous oxide. The vapor pressure of the fuels and oxidizers can be greater than about 30 psi, about 40 psi, about 50 psi, about 75 psi, about 100 psi, about 150 psi, about 200 psi, about 300 psi, about 400 psi, or about 500 psi, as described above. These can be the vapor pressures at 0 Celsius and likewise between about 0 C and about 100 C, or greater than 100 C.

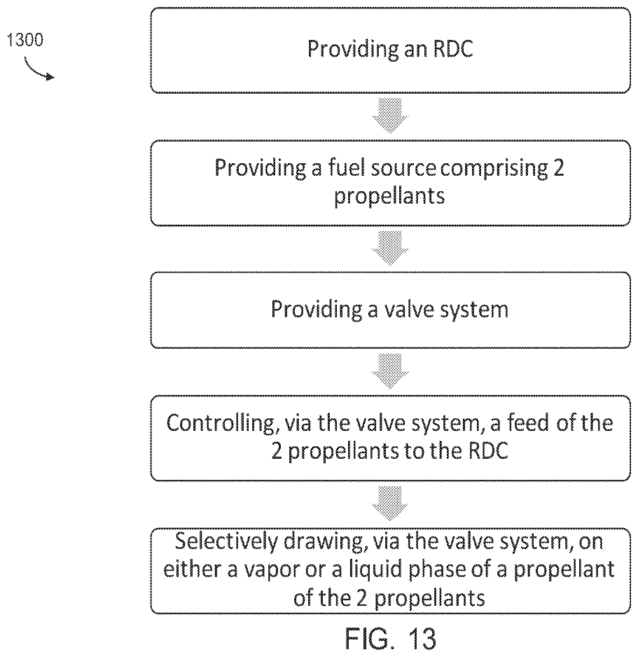

The RDC thruster can comprise thruster 400, 450, 500 or combinations thereof as described above. The RDC thruster can be connected to the propellants via feed systems such as those described in FIG. 10. The feed systems can comprise a numbers of valves, meters, sensors, and regulators to control both the relative amount of oxidizer and fuel proceeding to the thruster, as well as controlling the phase (e.g., liquid or gas) of the oxidizer, fuel, or both. The valves can selectively draw on one or more of the phases of the propellants, as shown in FIG. 13. As such, the method 1300 can comprise providing an RDC, fuel source comprising two propellants, and a valve system. The valve system can be used to control the feed of the propellants to the RDC and selectively draw on either a vapor or liquid phase of a propellant of the two chemical propellants.

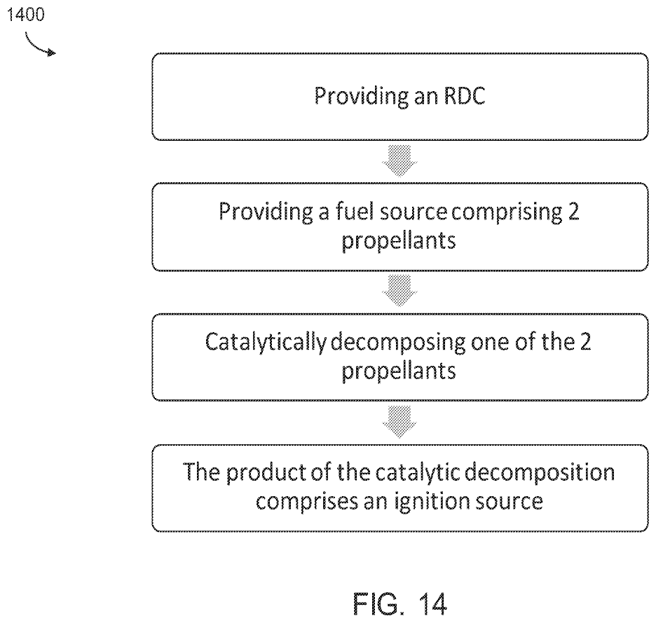

Causing a detonation in the RDC chamber can also comprise igniting an ignition source. In some cases, there are variable ignition sources that may be used. In some cases, there are five or more ignition sources that may be used. The ignition source may be a spark plug mounted normal to the combustion chamber. A spark box mounted elsewhere on the system may provide a high voltage to the spark plug, which may arc through the chamber to the inner wall to provide ignition energy. The ignition source may be a pre-detonator mounted normal or tangential to the chamber wall. The ignition source may be a flame torch mounted normal or tangential to the chamber wall. The ignition source may be injection of TEA-TEB (triethyl aluminum-triethyl borane) into the chamber. As shown in FIG. 14, the ignition source may be a catalytic decomposition of one or more of the propellants described herein. The ignition source may be a catalytic decomposition of one or more of the oxidizers. As such, the method 1400 can comprise providing an RDC, providing a fuel source comprising two propellants, and catalytically decomposing at least one of the two propellants. The product of the catalytic decomposition can comprise the ignition source.

A catalyst bed may be placed in line with either of the propellant feed systems, or other propellant feed system, to exothermically decompose it. Exothermal catalytic decomposition may provide energy for ignition. If the catalyst bed design is used, the thruster may be used in a monopropellant design by decomposing the oxidizer (e.g., nitrous oxide) due to its low thrust, low specific impulse. If the catalyst bed design is used, the thrust may also use bipropellant mode. The catalyst bed may comprise stacked screens. The catalyst bed may comprise of a packed bed of coated spherical beads. The catalyst bed may comprise meshes comprising a coating. The coating material can comprise one or more of noble metals, bare oxides, hexaaluminates, hydrotalcites, spinels, perovskites, mixed metal oxides, or any combination thereof. A catalyst bed can be placed in the oxidizer feed line to exothermically decompose the oxidizer on its way to the chamber. Once it arrives, it can ignite the propellant gases in the chamber and begin the detonation wave.

The detonation wave can travel around the drum or track of the annular combustion chamber. The kinetic energy from the detonation wave can be funneled to the nozzle through the chamber contraction (e.g., chamber contraction 518) to the combustor throat (e.g., throat 426 or 516) and to the aerospike nozzle (e.g., aerospike 428 or 524). By the time it has reached the nozzle, the kinetic energy may be transformed to thrust to exit the nozzle.

The thruster may comprise a cooling unit. The cooling unit may be configured to cool the RDC chamber. The cooling unit may be configured to cool the nozzle. The cooling unit may cool a portion of the RDC. The cooling unit may cool a throat of the nozzle. The cooling unit may be configured to cool the geometric throat of the nozzle. In some cases, there are various cooling designs. In some cases, the cooling design comprises full regenerative cooling with the fuel, the oxidizer, or both. This may include the full chamber and nozzle. The regenerative cooling loop may be used to pressurize (e.g., self-pressurize) one or both of the fuel and the oxidizer. In some cases, the cooling design may comprise regenerative cooling of a portion of the chamber and nozzle throat, with a printed nozzle of a material suitable for radiative cooling. In some cases, the cooling unit comprises a fully printed design of the radiative cooling material. In some cases, the cooling unit may be configured for partial regenerative cooling. The cooling unit can be configured for radiative cooling. Radiative cooling may refer to simply allowing heat to escape from a hot surface by emitting infrared radiation into space. Regenerative cooling may refer to actively cooling the thruster by circulating the propellant through channels (feed systems, manifold) thereby allowing the propellant to absorb heat before being injected into the chamber.

In some cases, the rotating detonation combustion chamber, the nozzle, or both comprise a superalloy or a ceramic configured to radiatively cool the rotating detonation combustion chamber, the nozzle, or both. In some cases, the rotating detonation combustion chamber, the nozzle, or both comprise a metal-based structure configured to regeneratively cool the rotating detonation combustion chamber, the nozzle, or both.

### Clauses

1. A thruster, the thruster comprising: a rotating detonation combustion chamber; and a fuel source operably connected to the rotating detonation combustion chamber, the fuel source comprising two chemical propellants, wherein each of the two chemical propellants comprises a liquid with a vapor pressure higher than an operating pressure of each of the two chemical propellants.

2. The thruster of clause 1, wherein each of the two chemical propellants comprises a liquid with a vapor pressure sufficient to self-pressurize each of the two chemical propellants.

3. The thruster of clause 1, wherein each of the two chemical propellants comprises a liquid with a vapor pressure greater than about 30 psi at 0 Celsius.

4. The thruster of clause 1, wherein each of the two chemical propellants comprises a liquid with a vapor pressure greater than about 30 psi from about 0 C to about 100 C.

5. The thruster of clause 1, wherein the two chemical propellants comprise an oxidizer and a fuel.

6. The thruster of clause 5, wherein the oxidizer comprises nitrous oxide.

7. The thruster of clause 5, wherein the oxidizer comprises a mixture of nitrous oxide and oxygen.

8. The thruster of any one of clauses 5 to 7, wherein the fuel comprises a fuel selected from the group consisting of: ethane, propane, n-butane, isobutane, ethylene, propylene, acetylene, ammonia, or combinations thereof.

9. The thruster of clause 1, further comprising a valve system configured to control a feed of each of the two chemical propellants to the rotating detonation combustion chamber.

10. The thruster of clause 9, wherein the valve system is configured to selectively draw on either a vapor or a liquid phase of a propellant of the two chemical propellants.

11. The thruster of clause 1, further comprising an ignition source, wherein the ignition source comprises a catalytic decomposition of one of the two chemical propellants.

12. The thruster of clause 11, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

13. A thruster, the thruster comprising: a rotating detonation combustion chamber; and a fuel source operably connected to the rotating detonation combustion chamber, the fuel source comprising two chemical propellants, wherein a first of the two chemical propellants comprises nitrous oxide.

14. The thruster of clause 13, wherein a second of the two chemical propellants comprises a fuel selected from the group consisting of: ethane, propane, n-butane, isobutane, ethylene, propylene, acetylene, ammonia, or combinations thereof.

15. The thruster of clause 14, wherein the fuel comprises ethane.

16. The thruster of clause 13, wherein each of the two chemical propellants comprises a liquid with a vapor pressure higher than an operating pressure of each of the two chemical propellants.

17. The thruster of clause 13, wherein each of the two chemical propellants comprises a liquid with a vapor pressure sufficient to self-pressurize each of the two chemical propellants.

18. The thruster of clause 13, wherein each of the two chemical propellants comprises a liquid with a vapor pressure greater than about 30 psi at 0 Celsius.

19. The thruster of clause 13, wherein the two chemical propellants comprise an oxidizer and a fuel.

20. The thruster of clause 19, wherein the oxidizer comprises a mixture of nitrous oxide and oxygen.

21. The thruster of clause 13, further comprising a valve system configured to control a feed of each of the two chemical propellants to the rotating detonation combustion chamber.

22. The thruster of clause 21, wherein the valve system is configured to selectively draw on either a vapor or a liquid phase of a propellant of the two chemical propellants.

23. The thruster of clause 13, further comprising an ignition source, wherein the ignition source comprises a catalytic decomposition of one of the two chemical propellants.

24. The thruster of clause 23, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

25. A thruster, the thruster comprising: a rotating detonation combustion chamber; a fuel source operably connected to the rotating detonation combustion chamber, the fuel source comprising two chemical propellants; and a valve system configured to control a feed of each of the two chemical propellants to the rotating detonation combustion chamber, wherein the valve system is configured to selectively draw on either a vapor or a liquid phase of a propellant of the two chemical propellants.

26. The thruster of clause 25, wherein each of the two chemical propellants comprises a vapor and a liquid phase.

27. The thruster of clause 25, wherein the valve system is configured to alternate between the two chemical propellants to cool the chamber or for injection into the chamber.

28. The thruster of clause 25, wherein each of the two chemical propellants comprises a liquid with a vapor pressure higher than an operating pressure of each of the two chemical propellants.

29. The thruster of clause 25, wherein each of the two chemical propellants comprises a liquid with a vapor pressure sufficient to self-pressurize each of the two chemical propellants.

30. The thruster of clause 25, wherein each of the two chemical propellants comprises a liquid with a vapor pressure greater than about 30 psi at 0 Celsius.

31. The thruster of clause 25, wherein the two chemical propellants comprise an oxidizer and a fuel.

32. The thruster of clause 31, wherein the oxidizer comprises nitrous oxide.

33. The thruster of clause 31, wherein the oxidizer comprises a mixture of nitrous oxide and oxygen.

34. The thruster of any one of clauses 31 to 33, wherein the fuel comprises a fuel selected from the group consisting of: ethane, propane, n-butane, isobutane, ethylene, propylene, acetylene, ammonia, or combinations thereof.

35. The thruster of clause 25, further comprising an ignition source.

36. The thruster of clause 35, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

37. The thruster of clause 35, wherein the ignition source comprises: (a) a spark plug mounted normal to the rotating detonation combustion chamber, wherein a spark box is configured to provide a voltage to the spark plug, wherein the spark plug is configured to arc through the rotating detonation combustion chamber to provide ignition energy; (b) a pre-detonator mounted normal or tangential to a wall of the rotating detonation combustion chamber; or (c) a catalytic decomposition of one of the two chemical propellants.

38. A thruster, the thruster comprising: a rotating detonation combustion chamber; a fuel source operably connected to the rotating detonation combustion chamber, the fuel source comprising two chemical propellants; and an ignition source, wherein the ignition source comprises a catalytic decomposition of one of the two chemical propellants.

39. The thruster of clause 38, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

40. The thruster of clause 38, wherein each of the two chemical propellants comprises a liquid with a vapor pressure higher than an operating pressure of each of the two chemical propellants.

41. The thruster of clause 38, wherein each of the two chemical propellants comprises a liquid with a vapor pressure sufficient to self-pressurize each of the two chemical propellants.

42. The thruster of clause 38, wherein each of the two chemical propellants comprises a liquid with a vapor pressure greater than about 30 psi at 0 Celsius.

43. The thruster of clause 38, wherein the two chemical propellants comprise an oxidizer and a fuel.

44. The thruster of clause 43, wherein the oxidizer comprises nitrous oxide.

45. The thruster of clause 43, wherein the oxidizer comprises a mixture of nitrous oxide and oxygen.

46. The thruster of any one of clauses 43 to 45, wherein the fuel comprises a fuel selected from the group consisting of: ethane, propane, n-butane, isobutane, ethylene, propylene, acetylene, ammonia, or combinations thereof.

47. The thruster of clause 38, further comprising a valve system configured to control a feed of each of the two chemical propellants to the rotating detonation combustion chamber.

48. The thruster of clause 47, wherein the valve system is configured to selectively draw on either a vapor or a liquid phase of a propellant of the two chemical propellants.

49. The thruster of any of the preceding clauses, wherein the thruster is configured to operate in a dual propellant mode or a single propellant mode, wherein in the single propellant mode the ignition source comprises the catalytic decomposition of the oxidizer.

50. The thruster of any of the preceding clauses, further comprising a catalyst bed, wherein the catalyst bed comprises stacked screens, a packed bed of coated spherical beads, meshes comprising a coating, or any combination thereof.

51. The thruster of clause 50, wherein the coating comprises one or more of noble metals, bare oxides, hexaaluminates, hydrotalcites, spinels, perovskites, mixed metal oxides, or any combination thereof.

52. The thruster of any of the preceding clauses, wherein a nozzle of the rotating detonation chamber comprises an aerospike.

53. The thruster of any of the preceding clauses, wherein the thruster is additively manufactured.

54. The thruster of clause 53, wherein the thruster is additively manufactured from a ceramic, a copper alloy, a steel alloy, a nickel-based alloy, a superalloy, or combinations thereof.

55. The thruster of clause 54, wherein the copper alloy comprises: GR-Cop 42 or GR-Cop 84.

56. The thruster of clause 54, wherein the nickel-based alloy comprises Inconel.

57. The thruster of clause 54, wherein the superalloy comprises C-103.

58. The thruster of any of the preceding clauses, wherein the rotating detonation combustion chamber is annular, wherein the annular chamber comprises an outer body and an inner center body.

59. The thruster of clause 58, wherein the annular chamber is shaped as a straight chamber, a chamber that tapers outward, or a chamber that tapers inward.

60. The thruster of any of the preceding clauses, wherein the thruster comprises a cooling unit.

61. The thruster of clause 60, wherein the cooling unit is configured to cool the rotating detonation combustion chamber and a nozzle.

62. The thruster of clause 61, wherein the cooling unit is configured to cool a portion of the rotating detonation combustion chamber and a throat of the nozzle.

63. The thruster of clause 62, wherein the nozzle comprises a printed nozzle of a material suitable for radiative cooling.

64. The thruster of clause 62 or 63, wherein the nozzle is partially or fully printed.

65. The thruster of any one of clauses 60 to 64, wherein the cooling unit is configured for regenerative cooling.

66. The thruster of clause 65, wherein the cooling unit comprises full regenerative cooling using either or both of the two chemical propellants.

67. The thruster of any one of clauses 60 to 66, wherein a regenerative cooling loop is used to pressurize either or both of the two chemical propellants.

68. The thruster of clause 60, wherein cooling unit comprises partial regenerative cooling.

69. The thruster of any one of clauses 60 to 68, wherein the cooling unit is configured for radiative cooling.

70. The thruster of any of the preceding clauses, wherein the rotating detonation combustion chamber, a nozzle, or both comprise a superalloy or a ceramic configured to radiatively cool the rotating detonation combustion chamber, the nozzle, or both.

71. The thruster of any of the preceding clauses, wherein the rotating detonation combustion chamber, a nozzle, or both comprise a metal-based structure configured to regeneratively cool the rotating detonation combustion chamber, the nozzle, or both.

72. A system comprising the thruster of any of the preceding clauses, further comprising: a tank for the each of the two chemical propellants.

73. The system of clause 72, wherein each of the two chemical propellants comprises a liquid with a vapor pressure higher than an operating pressure of each of the two chemical propellants.

74. The system of clause 72, wherein each of the two chemical propellants comprises a liquid with a vapor pressure sufficient to self-pressurize each of the two chemical propellants.

75. The system of clause 72, wherein each of the two chemical propellants comprises a liquid with a vapor pressure greater than about 30 psi at 0 Celsius.

76. The system of clause 72, wherein each of the two chemical propellants comprises a liquid with a vapor pressure greater than about 30 psi from about 0 C to about 100 C.

77. The system of clause 72, wherein the two chemical propellants comprise an oxidizer and a fuel.

78. The system of clause 77, wherein the oxidizer comprises nitrous oxide.

79. The system of clause 77, wherein the oxidizer comprises a mixture of nitrous oxide and oxygen.

80. The system of any one of clauses 77 to 79, wherein the fuel comprises a fuel selected from the group consisting of: ethane, propane, n-butane, isobutane, ethylene, propylene, acetylene, ammonia, or combinations thereof.

81. The system of clause 77, further comprising a valve system configured to control a feed of each of the two chemical propellants to the rotating detonation combustion chamber.

82. The system of clause 81, wherein the valve system is configured to selectively draw on either a vapor or a liquid phase of a propellant of the two chemical propellants.

83. The system of clause 81 or 82, wherein the valve system comprises one or more members selected from the group consisting of: an actuated valve configured to isolate fluid, a pressure regulator, and a check valve.

84. The system of clause 77, further comprising an ignition source, wherein the ignition source comprises a catalytic decomposition of one of the two chemical propellants.

85. The system of clause 84, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

86. A method of generating a detonation in a rotating detonation combustion chamber, the method comprising: providing a rotating detonation combustion chamber; providing a fuel source, wherein the fuel source comprises two chemical propellants, wherein each of the two chemical propellants comprises a liquid with a vapor pressure higher than an operating pressure of each of the two chemical propellants.

87. The method of clause 86, wherein each of the two chemical propellants comprises a liquid with a vapor pressure sufficient to self-pressurize each of the two chemical propellants.

88. The method of clause 86, wherein the two chemical propellants comprise an oxidizer and a fuel.

89. The method of clause 88, wherein the oxidizer comprises nitrous oxide.

90. The method of clause 88, wherein the oxidizer comprises a mixture of nitrous oxide and oxygen.

91. The method of any one of clauses 88 to 90, wherein the fuel comprises ethane, propane, n-butane, isobutane, ethylene, propylene, acetylene, ammonia, or combinations thereof.

92. The method of clause 86, wherein each of the two chemical propellants comprises a liquid with a vapor pressure greater than about 30 psi at 0 Celsius.

93. The method of clause 86, wherein each of the two chemical propellants comprises a liquid with a vapor pressure greater than about 30 psi from about 0 C to about 100 C.

94. The method of clause 86, further comprising controlling a feed, via a valve system, of each of the two chemical propellants to the rotating detonation combustion chamber.

95. The method of clause 94, further comprising selectively drawing, via the valve system, on either a vapor or a liquid phase of a propellant of the two chemical propellants.

96. The method of clause 86, further comprising catalytically decomposing one of the two chemical propellants, wherein the product of the catalytic decomposition comprises an ignition source.

97. The method of clause 96, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

98. A method of generating a detonation in a rotating detonation combustion chamber, the method comprising: providing a rotating detonation combustion chamber; providing a fuel source, wherein the fuel source comprises one or more chemical propellants, wherein a first of the two chemical propellants comprises nitrous oxide.

99. The method of clause 98, wherein a second of the two chemical propellants comprises a fuel selected from the group consisting of: ethane, propane, n-butane, isobutane, ethylene, propylene, acetylene, ammonia, or combinations thereof.

100. The method of clause 99, wherein the fuel comprises ethane.

101. The method of clause 98, wherein each of the two chemical propellants comprises a liquid with a vapor pressure higher than an operating pressure of each of the two chemical propellants.

102. The method of clause 98, wherein each of the two chemical propellants comprises a liquid with a vapor pressure sufficient to self-pressurize each of the two chemical propellants.

103. The method of clause 98, wherein each of the two chemical propellants comprises a liquid with a vapor pressure greater than about 30 psi at 0 Celsius.

104. The method of clause 98, further comprising controlling a feed, via a valve system, of each of the two chemical propellants to the rotating detonation combustion chamber.

105. The method of clause 104, further comprising selectively drawing, via the valve system, on either a vapor or a liquid phase of a propellant of the two chemical propellants.

106. The method of clause 98, further comprising catalytically decomposing one of the two chemical propellants, wherein the product of the catalytic decomposition comprises an ignition source.

107. The method of clause 106, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

108. A method of generating a detonation in a rotating detonation combustion chamber, the method comprising: providing a rotating detonation combustion chamber; providing a fuel source, wherein the fuel source comprises one or more chemical propellants; providing a valve system, controlling, via the valve system, a feed of each of the two chemical propellants to the rotating detonation combustion chamber, and selectively drawing, via the valve system, on either a vapor or a liquid phase of a propellant of the two chemical propellants.

109. The method of clause 108, wherein each of the two chemical propellants comprises a liquid with a vapor pressure higher than an operating pressure of each of the two chemical propellants.

110. The method of clause 108, wherein each of the two chemical propellants comprises a liquid with a vapor pressure sufficient to self-pressurize each of the two chemical propellants.

111. The method of clause 108, wherein each of the two chemical propellants comprises a liquid with a vapor pressure greater than about 30 psi at 0 Celsius.

112. The method of clause 108, wherein the two chemical propellants comprise an oxidizer and a fuel.

113. The method of clause 112, wherein the oxidizer comprises nitrous oxide.

114. The method of clause 112, wherein the oxidizer comprises a mixture of nitrous oxide and oxygen.

115. The method of any one of clauses 112 to 114, wherein the fuel comprises ethane, propane, n-butane, isobutane, ethylene, propylene, acetylene, ammonia, or combinations thereof.

116. The method of clause 112, further comprising catalytically decomposing one of the two chemical propellants, wherein the product of the catalytic decomposition comprises an ignition source.

117. The method of clause 116, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

118. A method of generating a detonation in a rotating detonation combustion chamber, the method comprising: providing a rotating detonation combustion chamber; providing a fuel source, wherein the fuel source comprises one or more chemical propellants; and catalytically decomposing one of the two chemical propellants, wherein the product of the catalytic decomposition comprises an ignition source.

119. The method of clause 118, wherein each of the two chemical propellants comprises a liquid with a vapor pressure higher than an operating pressure of each of the two chemical propellants.

120. The method of clause 118, wherein each of the two chemical propellants comprises a liquid with a vapor pressure sufficient to self-pressurize each of the two chemical propellants.

121. The method of clause 118, wherein each of the two chemical propellants comprises a liquid with a vapor pressure greater than about 30 psi at 0 Celsius.

122. The method of clause 118, wherein the two chemical propellants comprise an oxidizer and a fuel.

123. The method of clause 122, wherein the oxidizer comprises nitrous oxide.

124. The method of clause 122, wherein the oxidizer comprises a mixture of nitrous oxide and oxygen.

125. The method of any one of clauses 122 to 124, wherein the fuel comprises ethane, propane, n-butane, isobutane, ethylene, propylene, acetylene, ammonia, or combinations thereof.

126. The method of clause 118, further comprising controlling a feed, via a valve system, of each of the two chemical propellants to the rotating detonation combustion chamber.

127. The method of clause 126, further comprising selectively drawing, via the valve system, on either a vapor or a liquid phase of a propellant of the two chemical propellants.

128. The method of clause 118, further comprising catalytically decomposing one of the two chemical propellants, wherein the product of the catalytic decomposition comprises an ignition source.

129. The method of clause 128, wherein one of the two chemical propellants comprises an oxidizer, wherein the ignition source comprises the catalytic decomposition of the oxidizer, and wherein a catalyst bed is placed in line with some or all of a feed for the oxidizer to exothermically decompose the oxidizer.

130. The method of any of clauses 86 to 129, wherein the detonation can be generated in a dual propellant mode or a single propellant mode, wherein in the single propellant mode the ignition source comprises the catalytic decomposition of the oxidizer.

131. The method of any of clauses 86 to 130, further comprising a catalyst bed, wherein the catalyst bed comprises stacked screens, a packed bed of coated spherical beads, meshes comprising a coating, or any combination thereof.

132. The method of clause 131, wherein the coating comprises one or more of noble metals, bare oxides, hexaaluminates, hydrotalcites, spinels, perovskites, mixed metal oxides, or any combination thereof.

133. The method of any of clauses 86 to 132, wherein a nozzle of the rotating detonation chamber comprises an aerospike.

134. The method of any of clauses 86 to 133, wherein the rotating detonation combustion chamber is annular, wherein the annular chamber comprises an outer body and an inner center body.

135. The method of clause 134 wherein the annular chamber is shaped as a straight chamber, a chamber that tapers outward, or a chamber that tapers inward.

136. The method of any of clauses 86 to 135, further comprising cooling the rotating detonation chamber and a nozzle via a cooling unit.

137. The method of clause 136, wherein cooling comprises cooling, via the cooling unit, a portion of the rotating detonation combustion chamber and a throat of the nozzle.

138. The method of clause 137, wherein the nozzle comprises a printed nozzle of a material suitable for radiative cooling.

139. The method of clause 137 or 138, wherein the nozzle is partially or fully printed.

140. The method of clause 136, wherein the cooling unit is configured for regenerative cooling.

141. The method of clause 140, wherein the cooling unit comprises full regenerative cooling using either or both of the two chemical propellants.

142. The method of any one of clauses 136 to 141, wherein a regenerative cooling loop is used to pressurize either or both of the two chemical propellants.

143. The method of clause 136, wherein cooling unit comprises partial regenerative cooling.

144. The method of clause any one of clauses 136 to 143, wherein the cooling unit is configured for radiative cooling.

145. The method of any of clauses 86 to 144, wherein the rotating detonation combustion chamber, a nozzle, or both comprise a superalloy or a ceramic configured to radiatively cool the rotating detonation combustion chamber, the nozzle, or both.

146. The method of any of clauses 86 to 145, wherein the rotating detonation combustion chamber, a nozzle, or both comprise a metal-based structure configured to regeneratively cool the rotating detonation combustion chamber, the nozzle, or both.

147. The method of any one of clauses 86 to 146, further comprising providing an injector, wherein the injector is configured to inject the one or more chemical propellants into the rotating detonation combustion chamber.

148. The method of clause 147, further comprising injecting the one or more chemical propellants into the rotating detonation combustion chamber.

149. The method of clause 147 or 148, wherein the injector is configured to mix the two chemical propellants.

150. The method of clause 149, further comprising mixing the two chemical propellants prior to injecting the one or more chemical propellants into the rotating detonation combustion chamber.

151. A thruster, the thruster comprising: a rotating detonation combustion chamber; and a fuel source operably connected to the rotating detonation combustion chamber, the fuel source comprising two chemical propellants, wherein each of the two chemical propellants comprises a liquid with a vapor pressure sufficient to self-pressurize each of the two chemical propellants.

152. The thruster of clause 151, further comprising the thruster of any one of clauses 1-71.

### Definitions

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers, and also represent an amount close to the stated amount that still performs a desired function or achieves a desired result.

The term “about” or “approximately” may mean within an acceptable error range for the particular value, which will depend in part on how the value is measured or determined, e.g., the limitations of the measurement system. For example, the terms “approximately”, “about”, and “substantially” may refer to an amount that is within less than 10% of, within less than 5% of, within less than 1% of, within less than 0.1% of, and within less than 0.01% of the stated amount. For example, “about” may mean within 1 or more than 1 standard deviation, per the practice in the art. Alternatively, “about” may mean a range of up to 20%, up to 10%, up to 5%, or up to 1% of a given value. As used herein, the term “about” a number refers to that number plus or minus 10% of that number. The term “about” a range refers to that range minus 10% of its lowest value and plus 10% of its greatest value. Where particular values are described in the application and claims, unless otherwise stated the term “about” meaning within an acceptable error range for the particular value may be assumed.

As used in the specification and claims, the singular forms “a”, “an” and “the” include plural references unless the context clearly dictates otherwise. For example, the term “a sample” includes a plurality of samples, including mixtures thereof.

The section headings used herein are for organizational purposes only and are not to be construed as limiting the subject matter described.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

1. A thruster, the thruster comprising:
a rotating detonation combustion chamber; and
a fuel source fluidically connected to the rotating detonation combustion chamber, the fuel source comprising a plurality of chemical propellants, wherein a first and a second chemical propellant of the plurality of chemical propellants comprises a liquid with a vapor pressure higher than an operating pressure of the first and the second chemical propellant of the plurality of chemical propellants.

2. The thruster of claim 1, wherein the first and the second chemical propellant of the plurality of chemical propellants comprises a liquid with a vapor pressure sufficient to self-pressurize the first and the second chemical propellant of the plurality of chemical propellants.

3. (canceled)

4. The thruster of claim 1, wherein the first and the second chemical propellant of the plurality of chemical propellants comprises a liquid with a vapor pressure greater than about 30 psi from about 0 C to about 100 C.

5. The thruster of claim 1, wherein the first and the second chemical propellant of the plurality of chemical propellants comprise an oxidizer and a fuel.

6. The thruster of claim 5, wherein the oxidizer comprises one or more of nitrous oxide or oxygen.

7. (canceled)

8. The thruster of claim 5, wherein the fuel comprises a fuel selected from the group consisting of: ethane, propane, n-butane, isobutane, ethylene, propylene, acetylene, ammonia, or combinations thereof.

9. The thruster of claim 1, further comprising a valve system configured to control a feed of the first and the second chemical propellant of the plurality of chemical propellants to the rotating detonation combustion chamber, wherein the valve system is configured to one or more of (a) to selectively draw on either a vapor or a liquid phase of a propellant of the first and the second chemical propellant of the plurality of chemical propellants, or (b) to alternate between the first and the second chemical propellant of the plurality of chemical propellants to cool the chamber or for injection into the chamber.

10. (canceled)

11. The thruster of claim 1, further comprising an ignition source, wherein the ignition source comprises a catalytic decomposition of an oxidizer of the first and the second chemical propellant of the plurality of chemical propellants, and wherein a catalyst bed is placed in line with some or all of a feed for the oxidizer to exothermically decompose the oxidizer.

12.-36. (canceled)

37. The thruster of claim 11, wherein the ignition source comprises: (a) a spark plug mounted normal to the rotating detonation combustion chamber, wherein a spark box is configured to provide a voltage to the spark plug, wherein the spark plug is configured to arc through the rotating detonation combustion chamber to provide ignition energy; (b) a pre-detonator mounted normal or tangential to a wall of the rotating detonation combustion chamber; or (c) a catalytic decomposition of the first or the second chemical propellant of the plurality of chemical propellants.

38.-48. (canceled)

49. The thruster of claim 1, wherein the thruster is configured to operate in a dual propellant mode or a single propellant mode, wherein in the single propellant mode the ignition source comprises the catalytic decomposition of the oxidizer.

50. The thruster of claim 1, further comprising a catalyst bed, wherein the catalyst bed comprises stacked screens, a packed bed of coated spherical beads, meshes comprising a coating, or any combination thereof.

51. The thruster of claim 50, wherein the coating comprises one or more of noble metals, bare oxides, hexaaluminates, hydrotalcites, spinels, perovskites, mixed metal oxides, or any combination thereof.

52. The thruster of claim 1, wherein a nozzle of the rotating detonation chamber comprises an aerospike.

53. (canceled)

54. The thruster of claim 1, wherein the thruster is additively manufactured from a ceramic, a copper alloy, a steel alloy, a nickel-based alloy, a superalloy, or combinations thereof.

55.-57. (canceled)

58. The thruster of claim 1, wherein the rotating detonation combustion chamber is annular, wherein the annular chamber comprises an outer body and an inner center body, wherein the annular chamber is shaped as a straight chamber, a chamber that tapers outward, or a chamber that tapers inward.

59. (canceled)

60. The thruster of claim 1, wherein the thruster comprises a cooling unit configured to cool at least a portion of the rotating detonation combustion chamber and a nozzle.

61. (canceled)

62. (canceled)

63. The thruster of claim 60, wherein the nozzle comprises a partially printed or fully printed nozzle of a material suitable for radiative cooling.

64. (canceled)

65. The thruster of claim 60, wherein the cooling unit is configured for partial or full regenerative cooling using either or both of the first and the second chemical propellant of the plurality of chemical propellants.

66. (canceled)

67. The thruster of claim 60, wherein a regenerative cooling loop is used to pressurize either or both of the first and the second chemical propellant of the plurality of chemical propellants.

68.-69. (canceled)

70. The thruster of claim 1, wherein the rotating detonation combustion chamber, a nozzle, or both comprise one or more of a superalloy, a metal-based structure, or a ceramic configured to radiatively cool the rotating detonation combustion chamber, the nozzle, or both.

71.-152. (canceled)
